(19) United States
(12) Patent Application Publication
(10) Pub. No.: US 2026/0200805 A1
(43) Pub. Date: Jul. 16, 2026

(54) METHOD FOR GUIDING A MOULDING MATERIAL IN A MOULDING MATERIAL CYCLE COMPRISING TWO OR MORE CYCLES

(71) Applicant: HÜTTENES-ALBERTUS Chemische Werke Gesellschaft mit beschränkter Haftung, Düsseldorf (DE)

(72) Inventors: Cornelis GREFHORST, Winterswijk (NL); Stefan ZINGREBE, Lemgo (DE); You WU, Holle (DE); Michael ARNDT-ROSENAU, Hannover (DE)

(73) Assignee: HÜTTENES-ALBERTUS Chemische Werke Gesellschaft mit beschränkter Haftung, Düsseldorf (DE)

(21) Appl. No.: 19/135,984

(22) PCT Filed: Dec. 6, 2023
(86) PCT No.: PCT/EP2023/084448

§ 371 Date: Jun. 5, 2025

(30) Foreign Application Priority Data
Dec. 6, 2022 (EP) 22211814.3

(51) Int. Cl. C04B 35/622; C04B 33/132

(52) U.S. Cl. CPC C04B 35/62204; C04B 33/132; C04B 2235/3218; C04B 2235/349; C04B 2235/5463; C04B 2235/61

(57) ABSTRACT

What is described is a method of guiding a molding material in a molding material cycle comprising two or more loops.

The invention relates a method of guiding a molding material in a molding material cycle comprising two or more loops.

Clays that are used for binding of molding materials typically contain smectites. Examples of such smectite-containing clays are bentonites, in particular sodium and calcium bentonites, which contain sodium and calcium in addition to the elements magnesium, aluminum and silicon. Other smectite-containing clays are hectorite, saponite, nontronite, beidellite or sauconite. Clays such as kaolinite or illite can be used as clay-containing binders in a mixture with smectite-containing clays.

The smectite-containing clay preferably has a proportion of montmorillonite of 50% by weight or more, more preferably 60% by weight or more, more preferably 70% by weight or more. If the proportion of montmoril-Ionite in a naturally occurring smectite-containing clay is too low, it can be increased by purification. This is applicable to bentonite in particular.

For example, sodium bentonite may contain 70% to 95% by weight of montmorillonite, where the residual components that occur include quartz, opal, cristobalite, feldspar, biotite, clinoptilite, calcite, gypsum inter alia.

Accordingly, the terms “smectite-containing clays” and “bentonite” are used in this document both for corresponding clays obtained from natural sources and for those that have been produced by purification of naturally occurring clays.

In this document, the term “clay-bound mold” is used, where appropriate, for casting molds bound with a smectite-containing clay. What this always means is casting molds bound with a smectite-containing clay.

In the foundry industry, preference is given to using smectite-containing clays in the form of sodium bentonite or calcium bentonite and/or mixtures thereof, where these mixtures are in some cases produced in situ by addition of salts and resulting ion exchange.

A useful mold base material is any sand that can constitute a foundry mold and can retain this shape at high temperatures and in contact with hot metal. Typical sands are silica sand, olivine sand, chromite sand, zirconium sand, and also synthetically produced ceramic sands, or mixtures of these sands. Typically, a mold contains at least 40% sand, preferably more than 50% sand, more preferably more than 60% sand and most preferably more than 70% sand.

In industrial practice, clay-bound casting molds are generally made from a molding material which, in addition to the smectite-containing clay as binder and the mold base material, also contains additives and water. Such molding materials are also referred to as “green sand” or “wet casting sand”. Compaction of the molding material leads to consolidation and hence ensures sufficient dimensional stability.

In industrial practice, a molding material with smectite-containing clay as binder is typically used in a molding material cycle.

What is meant by a molding material cycle for the purposes of the present disclosure is that molding material from molds used for casting (“molding material that has been used for casting”, also referred to as used sand) is processed and used for production of new molding material, from which molds are again made, which are used for casting. The mold base material present in the molding material therefore at least partly forms a constituent of processed molding material from at least one clay-bound mold that has already been used for casting.

A molding material cycle in the context of the present disclosure consists of at least two successive loops overtime. Two loops of one molding material cycle (that are not necessarily immediately consecutive) can therefore be distinguished as the earlier loop and the later loop. If the molding material cycle consists of only two loops, the first loop in the time sequence is the earlier loop, and the second loop in the time sequence is the later loop.

One loop of this molding material cycle can be described by the following characteristic steps (cf. FIG. for description of the steps hereinafter):
(Step 1) producing the molding material, i.e. producing a molding material comprising processed molding material from an earlier loop and aggregates (see below)
(Step 2) producing the mold, i.e. producing a smectite-containing clay-bound mold from the molding material produced in step (1),
(Step 3) casting, i.e. producing a casting by casting in the mold produced in step (2)
(Step 4) dividing, i.e. dividing the casting produced in step (3) from the mold, resulting in a molding material that has been used for casting and comprises material from the mold that has been used for casting
(Step 5) processing the molding material that has been used for casting, i.e. processing the molding material that has been used for casting from step (4), so as to obtain a first processed molding material for production of a new molding material in step (1) of a later loop.

It is preferable in particular cases that one, more than one or all loops of the molding material cycle include further steps, and/or individual steps among those mentioned have further features. Details of this will be apparent from the following description, and from the appended claims and drawings.

In each loop of the above-described molding material cycle, in step (3), a casting is produced by casting the mold produced in step (2). This significantly physically alters the molding material through thermal and chemical stress in the course of casting (step (3) of the loop). In order to enable a molding material cycle, the molding material that has been used for casting has to be processed.

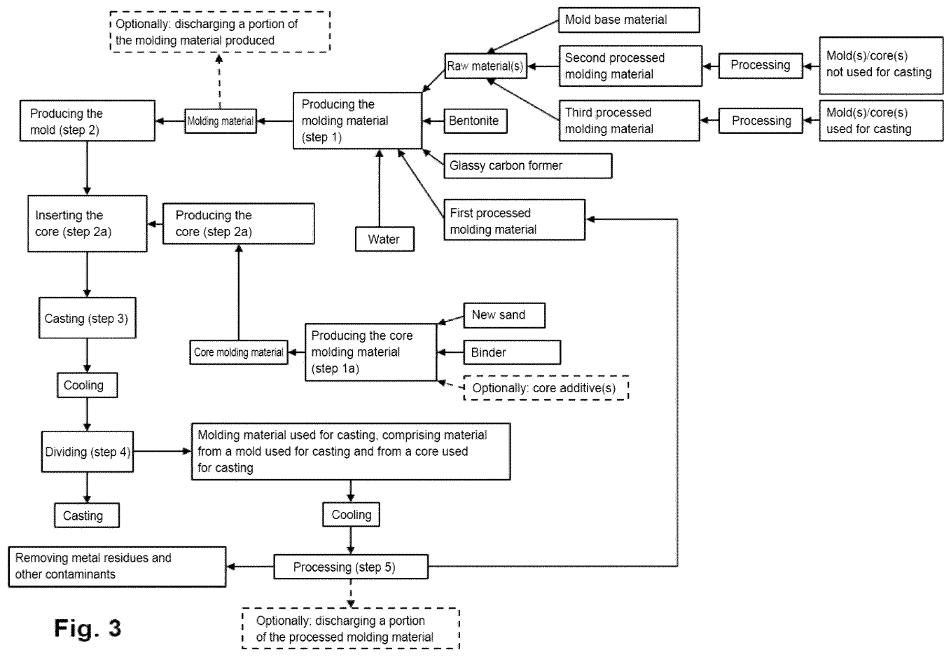

In some cases, in particular for production of castings with complex geometry, in step (3), a casting is produced by casting the mold produced in step (2) with one or more inserted cores (cf. FIG. 3). Cores used in clay-bound molds are typically not clay-bound. Such cores are typically produced with an organic binder, for example a polyurethane or a phenolic resin, or with a non-clay-containing inorganic binder, for example a waterglass-containing binder. If the casting produced in step (3) is divided from the mold and the cores in step (4), the result is typically a molding material that has been used for casting and contains material from the cores that have been used for casting (used core sand).

The processing of the molding material that has been used for casting in step (5) results in a processed molding material that remains in the molding material cycle. Thus, a portion of the mold base material used (generally quartz sand) remains as a constituent of the processed molding material that has been used for casting in the molding material cycle.

The processing regularly comprises comminuting of the molding material that has been used for casting (grain singularization) and substantial removal of metal residues and other contaminants, for example contaminants in the form of auxiliary products from the casting process (core marks, feeder residues, etc.).

The thermal, mechanical and possibly even chemical stress in the course of casting gives rise to wear products, for example sand fines, inactive clay fractions, decomposition products of the additives, in particular of the glassy carbon formers, reaction products of core binders, and oolitized grains of the mold base material.

In order that such wear products do not accumulate in the molding material cycle and/or the molding material properties are not adversely affected, or the required active components of the binder (smectite-containing clay) and the additives do not fall to too low a level, aggregates are added in a respective subsequent loop in step (1) in the course of production of the molding material, i.e. the processed molding material is refreshed by the aggregates. In order to keep the mass of the molding material in the cycle constant, a corresponding amount of molding material is discharged from the molding material cycle. This can be done prior to refreshing by means of the aggregates (i.e. in step (5)), or after the refreshing by means of the aggregates.

The aggregates typically include smectite-containing clay, water, additives (see below) and one or more raw materials from the group consisting of
fresh mold base material (new sand),
second processed molding material produced by processing molds that have not been used for casting and/or cores and/or parts thereof
third processed molding material produced by processing molds and/or cores and/or parts thereof that have been produced and used for casting outside the molding material cycle in question.

The aggregates (especially the bentonite) preferably also include water.

The molds and cores from which the second and the third processed molding material as defined above is obtained need not be clay-bound. In particular, the cores are typically not clay-bound but are produced with a customary organic binder, e.g. polyurethane, in particular polyurethane formed in the cold-box process, or with a phenolic resin in the form of a resol, in particular those resols that are used in the hotbox or warmbox process, or a novolak, in particular novolaks that are used in the Croning process or mask forming process.

In every loop of an industrial molding material cycle, the aim in casting is to achieve an essentially uniform quality of the castings. By means of controlled supply and removal of constituents of the molding material, it is possible to achieve essentially constant, optimal molding material properties in the molding material cycle (molding material conditioning). In each loop, the molding material is conditioned, i.e. optimized, by determining the required addition rates of smectite-containing clay (addition optional), additives, water and new sand, or second and third processed molding material as defined above, and also by determining the amount of used sand to be removed and by determining machine parameters such as mixing time or cooling intensity.

Molding materials for the production of clay-bound casting molds in industrial practice typically contain additives in the form of what are called glassy carbon formers.

Glassy carbon formers (also referred to as glassy carbon carriers, cf. https://www.giesserei-praxis.de/gies-serei-lexikon/glossar/glanzkohlenstoff) are molding material additives having the ability to form hydrocar-bonaceous gases that are carbonized on casting in the reducing atmosphere of the molding material cavity. This gives rise to glassy carbon. Examples of glassy carbon formers that are used customarily include hard coal dusts, pitches, bitumens, resins, oils, plastics and mixtures thereof.

Glassy carbon formers are especially added to clay-bound molding materials for iron casting. The glassy carbon prevents wetting by the liquid casting material at the metal/mold interface. In addition, glassy carbon formers in the molding material can buffer quartz expansion and prevent sand expansion defects. However, rising proportions of hard coal dust or other glassy carbon formers and higher proportions of the decomposition products (coke) of the glassy carbon formers in the processed molding material increase the water demand of the molding material. An elevated amount of water in the molding material can lead to casting defects, for example explosion penetration.

Since glassy carbon formers are thermally decomposed and carbonized in the course of casting, the corresponding losses in the molding material cycle have to be regularly replaced in industrial practice by supply of fresh glassy carbon formers. For this purpose, glassy carbon formers are freshly added at least in some loops, preferably in all loops, of the molding material cycle.

A major disadvantage of the use of glassy carbon formers is the release of emissions, for example in the form of CO, CO₂, NOx and volatile organic compounds, in particular aromatic hydrocarbons such as benzene, toluene and xylenes (“BTX emissions”), but also polycyclic aromatics. In addition, volatile sulfur-containing compounds are usually also emitted, since glassy carbon formers frequently contain sulfur and/or sulfur-containing impurities. Another problem is the significant risk of dust explosions and spontaneous ignition in the handling of glassy carbon formers. For that reason, in industrial foundry operation, glassy carbon formers are typically used in the production of clay-bound molds in the form of a mixture with the smectite-containing clay, in particular bentonite, that has been made up by the supplier.

For the reasons mentioned, it is desirable and necessary to restrict the use of glassy carbon formers or to replace glassy carbon formers with suitable alternatives at least in a significant proportion.

U.S. Pat. No. 5,372,636 A discloses a molding material comprising sand, a sodium smectite clay (in particular sodium bentonite) and at least one oxide, salt (in particular carbonate) or hydroxide of a metal, e.g. aluminum, calcium, iron, sodium, magnesium, boron or zinc. There is no disclosure of cycling of the molding material. Thus, this document does not provide any information at all as to whether such molding materials are suitable for use in a molding material cycle.

WO 03/066253 A1 describes a process for producing a molding material for foundry purposes, which is cycled in particular, according to which a non-water-swellable material is added to a mixture of a granular mass and aggregates, for example a binder, e.g. bentonite, and water. Nonswellable porous material used is in particular framework silicates or tectosilicates, for example zeolites, pumice or pumice stones, allo-phane, imogolite, kieselguhr, polygarskite, sepiolite, diatomaceous earth, or (acid- and/or heat-treated) clays.

CN 108356214 discloses molding material mixtures comprising sand, water, bentonite and an additive having the following composition
SiO₂ 50-85 wt %
Al₂O₃ 9-45 wt %
MgO 0.2-3 wt %
Fe₂O₃ 1-8 wt %
CaO 1-7 wt %
Fe₃O₄ 0.4-8 wt %

The additive is produced by mixing the individual oxides. It is intended to replace glassy carbon formers. Molding materials containing this additive should have good recyclability. Illustrative molding materials were used for two to four months.

The primary object of the present invention is that of reducing carbon-based emissions and/or carbon-based casting defects. Carbon-based emissions include, for example, emissions in the form of CO, CO₂, and volatile organic compounds, in particular aromatic hydrocarbons such as benzene, toluene and xylenes (“BTX emissions”), but also polycyclic aromatics.

This object is achieved by a method of guiding a molding material in a molding material cycle comprising two or more loops, comprising the following steps:
in an earlier loop of said two or more loops of the molding material cycle, casting in a mold comprising the smectite-containing clay-bound molding material, resulting in a molding material that has been used for casting,
processing the molding material used for casting so as to result in a first processed molding material,
in a later loop of said two or more loops of the molding material cycle, producing a molding material comprising
   (i) first processed molding material,
   and
   (ii) aggregates comprising
      one or more raw materials from the group consisting of
      mold base material,
      a second processed molding material produced by processing molding material from molds that have not been used for casting and/or cores and/or parts thereof,
      a third processed molding material produced by processing molds used for casting outside the molding material cycle and/or cores and/or parts thereof,
   an additive containing at least one dehydratable inorganic compound that eliminates water at a temperature of 150° C. or more,
   and optionally smectite-containing clay, preferably bentonite,
wherein at least one of the processed molding materials contains inorganic binder and/or reaction products thereof.

The inorganic binder preferably contains waterglass.

The aggregates preferably also comprise water.

The processed molding materials preferably do not contain any organic binders, and more preferably do not contain any organic material at all. The processed molding materials most preferably do not contain any carbon or any carbon carrier.

The carbon content of a molding material is determined by elemental analysis and includes carbon components from organic carbon carriers and from inorganic carbon carriers. Organic carbon carriers are in particular glassy carbon formers, organic binders, organic additives and residues or decomposition products of glassy carbon formers, organic binders and organic additives. Inorganic carbon carriers are in particular carbonates, which may be present as additive in the molding material.

In molding materials with smectite-containing clay as binder, the carbon content can be lowered in particular by reducing or avoiding the use of glassy carbon formers.

Reducing or even avoiding the use of glassy carbon formers conserves fossil resources. A further object which is achieved by the present invention is thus that of providing a resource-conserving molding material cycle.

Reducing or even avoiding the use of glassy carbon formers reduces or even eliminates the risk of dust explosions and spontaneous ignition in the course of transport, storage and handling of the glassy carbon formers. A further object achieved by the present invention is thus that of reducing the risk of dust explosions and spontaneous ignition in the course of transport, storage and handling of the glassy carbon formers.

Reducing or even avoiding the use of glassy carbon formers results in formation of a lower level of pyrolysis products in the course of casting that contaminate the molding material used for casting or the molding material discharged from the molding material cycle. The relatively low levels of carbon and sulfur in the molding material used for casting that are associated with a reduction in the use of glassy carbon formers are likewise advantageous for the landfill deposition of non-reusable molding material components. A further object achieved by the present invention is thus that of facilitating further use or landfill deposition of molding material that has been used for casting.

Further objects achieved by the present invention are that of reducing sulfur-based emissions and NOx emissions during a molding material cycle comprising two or more loops.

A further object achieved by the present invention is that of reducing the odor nuisance released in the course of casting.

The reduction in the proportion of glassy carbon is not to have an unacceptable effect on the properties of the molding material, molds produced therefrom and the castings produced therewith.

The molding material cycle to which the method of the invention relates is preferably an industrial molding material cycle in a foundry, preferably a foundry with at least one production line integrated into the molding material cycle, and optionally at least one further production line in which non-clay-bound molds and/or cores are produced and/or used for casting.

It is not absolutely necessary for the above-defined additive to be added in every loop of the molding material cycle. A molding material cycle of the invention may comprise individual loops in which this additive is not added.

Further particulars, details, benefits and preferred embodiments of the method of the invention will be apparent from the following description, and from the appended claims and drawings.

The achievement of the objects defined above is based on the use of an additive which is of similar efficacy to the glassy carbon formers used in the prior art in preventing mold expansion defects, in the separation between metal and molding material, and in promoting mold decay. It has been found that, surprisingly, dehydratable inorganic compounds that eliminate water at a temperature of 150° C. or more can be of similar efficacy in preventing mold expansion defects and in promoting mold breakdown to the glassy carbon formers used in the prior art.

Dehydration means the elimination of water bound chemically (e.g. in the form of hydroxide ions) or physically (e.g. as water of crystallization in hydrates) by heating.

Preferably, the dehydratable inorganic compounds contained in the additive to be used in accordance with the invention are compounds from the group of hydroxides and hydrate salts of metals. The term “hydroxides” as used here also includes oxide hydroxides. Preference is given to hydroxides and hydrate salts of metals in the +11 or +111 oxidation state, especially preferably hydroxides of metals in the +11 or +111 oxidation state. Especially preferred are magnesium hydroxide (especially in the form of brucite) and aluminum hydroxide; most preferred is aluminum trihydroxide Al(OH)₃. The aluminum trioxide may be in various modifi-cations, in particular in the form of gibbsite, bayerite or nordstrandite, and also in minerals in combination with other hydroxides or oxides.

The additive preferably contains one or both compounds from the group consisting of aluminum hydroxide and magnesium hydroxide. Preferably, the proportion of aluminum hydroxide is at least 80%, further preferably at least 90%, more preferably at least 95% and especially preferably at least 99%, based on the total mass of aluminum hydroxide and magnesium hydroxide in the additive.

Preferably, the additive to be used in accordance with the invention does not include carbon or carbon carriers.

In the method of the invention, in an earlier loop of the two or more loops of the molding material cycle, a mold comprising smectite-containing clay-bound molding material is used for casting, producing a casting. The use of the mold for casting results in a molding material that has been used for casting. The molding material used for casting is processed in the manner described above so as to result in a first processed molding material. In order to keep the mass of the cycled molding material constant, a portion of the molding material that has been used for casting is optionally discharged in the course of processing, so as to result in discharged molding material.

However, it is not absolutely necessary for processed molding material to be discharged in every loop of the molding material cycle. A molding material cycle of the invention may comprise individual loops in which no processed molding material is discharged.

In a later loop of the molding material cycle, a molding material is produced, comprising (i) first processed molding material as defined above, and (ii) aggregates. These aggregates include
the additive as defined above
and one or more raw materials from the group consisting of
   mold base material, especially quartz sand
   a second processed molding material produced by processing molding material from molds that have not been used for casting and/or cores and/or parts thereof,
   a third processed molding material produced by processing molds used for casting outside the molding material cycle and/or cores and/or parts thereof,
and optionally smectite-containing clay, preferably bentonite.

If a portion of the molding material used for casting has not already been discharged after processing, it is then possible, in order to keep the mass of the cycled molding material constant, to discharge a portion of the molding material produced so as to result in discharged molding material. However, this is not absolutely necessary. A molding material cycle of the invention may comprise individual loops in which no molding material is discharged.

At least one of the processed molding materials used in the method of the invention (second and third processed molding material as defined above) comprises inorganic binder and/or reaction products thereof. Preferably, the inorganic binder contains waterglass, in particular waterglass hardened thermally or by sparging with CO₂. Cores or molds that have been used for casting contain reaction products of the inorganic binder that have been formed in the course of casting.

The molding material produced in a later loop of the molding material cycle comprises one or more or all of the abovementioned raw materials. The mold base material used as raw material preferably includes fresh quartz sand (new sand), or silica sand, olivine sand, chromite sand, zirconium sand, or synthetically produced ceramic sands, or mixtures of these sands.

The smectite-containing clay is preferably bentonite, in particular from the group consisting of sodium bentonite and calcium bentonite and mixtures thereof.

The second processed molding material as defined above is produced by processing molding material from molds that have not been used for casting and/or cores and/or parts thereof. The molds and/or cores that have not been used for casting are molds and/or cores that have not been used for casting for various reasons, for example owing to processing defects or lack of dimensional accuracy.

The third processed molding material as defined above is produced by processing molding material from molds that have been used for casting outside the molding material cycle in question and/or cores and/or parts thereof, i.e. molds and cores used for casting, for example, on a different production line.

There is preferably no use of processed molding material containing material from molds that have been used for casting or not used for casting and/or cores and/or parts thereof, where the molds and/or cores have been produced with an organic binder.

Preferably, the molding material produced in the later cycle has one or more of the following parameters:
a concentration of less than 1.5%, preferably less than 0.8%, carbon, based on the mass of the molding material, determined by elemental analysis
a concentration of less than 0.1%, preferably less than 0.05%, of nitrogen, based on the mass of the molding material, determined by elemental analysis
a concentration of less than 0.05%, preferably less than 0.03%, sulfur, based on the mass of the molding material, determined by elemental analysis
an ignition loss of at most 5%, preferably at most 3.5%, determined in accordance with VDG Merkblatt P33 (April 1997).

More preferably, the molding material produced in the later loop has one or more of the following parameters:
a concentration of less than 0.8%, preferably less than 0.4%, more preferably less than 0.2%, of carbon, based on the mass of the molding material, determined by elemental analysis
a concentration of less than 0.05%, preferably less than 0.03%, more preferably less than 0.01%, nitrogen, based on the mass of the molding material, determined by elemental analysis
a concentration of less than 0.03%, preferably less than 0.01%, most preferably less than 0.005%, of sulfur, based on the mass of the molding material, determined by elemental analysis
an ignition loss of not more than 3.5%, preferably not more than 3%, more preferably not more than 2.5%, determined in accordance with VDG-Merkblatt P33 (April 1997).

All the abovementioned parameters of the molding material are preferably in the abovementioned preferred ranges, especially in the abovementioned particularly preferred ranges.

In one embodiment of the method of the invention, casting in the earlier loop is effected in a mold with at least one inserted core that has been produced with an inorganic binder. The result is a molding material that has been used for casting and comprises material from the mold used for casting and material from the core used for casting. The material from the core used for casting comprises reaction products of the inorganic binder formed in the course of casting.

Cores used in clay-bound molds are typically not clay-bound. In the embodiment of the method of the invention which is being described here, these cores are produced with an inorganic binder. Preferably, the inorganic binder contains waterglass, in particular waterglass hardened thermally and/or by sparging with CO₂. The molding material used for casting that results from the earlier loop of the molding material cycle and the resulting first processed molding material thus contain material from at least one mold used for casting and from at least one core used for casting that were used for casting in the same casting operation.

In this embodiment of the method of the invention, a second processed molding material can be used, containing material from molds that have not been used for casting and/or cores and/or parts thereof, where the molds and/or cores have preferably been produced with an inorganic binder, e.g. a binder containing waterglass, and/or a third processed molding material containing material from molds that have been used for casting and/or cores and/or parts thereof, where the molds and/or cores have preferably been produced with an inorganic binder, e.g. a binder containing waterglass.

There is preferably no use of processed molding material containing material from molds that have been used for casting or not used for casting and/or cores and/or parts thereof, where the molds and/or cores have been produced with an organic binder, e.g. phenolic resin or polyurethane.

In another embodiment of the method of the invention, in the earlier loop, casting is effected in a mold without an inserted core, such that the first processed molding material does not contain material from cores used for casting. In this embodiment of the method of the invention, the second processed molding material contains material from cores and/or molds and/or parts thereof that have not been used for casting, where the molds and/or cores have been produced with an inorganic binder, and/or the third processed molding material contains material from molds that have been used for casting and/or cores and/or parts thereof, where the molds and/or cores have been produced with an inorganic binder. Preferably, the inorganic binder contains waterglass, in particular waterglass hardened thermally and/or by sparging with CO₂. Material from molds and core that have been used for casting comprises reaction products of the inorganic binder formed in the course of casting.

There is preferably no use of processed molding material containing material from molds that have been used for casting or not used for casting and/or cores and/or parts thereof, where the molds and/or cores have been produced with an organic binder, e.g. phenolic resin or polyurethane.

In the method of the invention, the cycled molding material is preferably used for production of molds for iron casting.

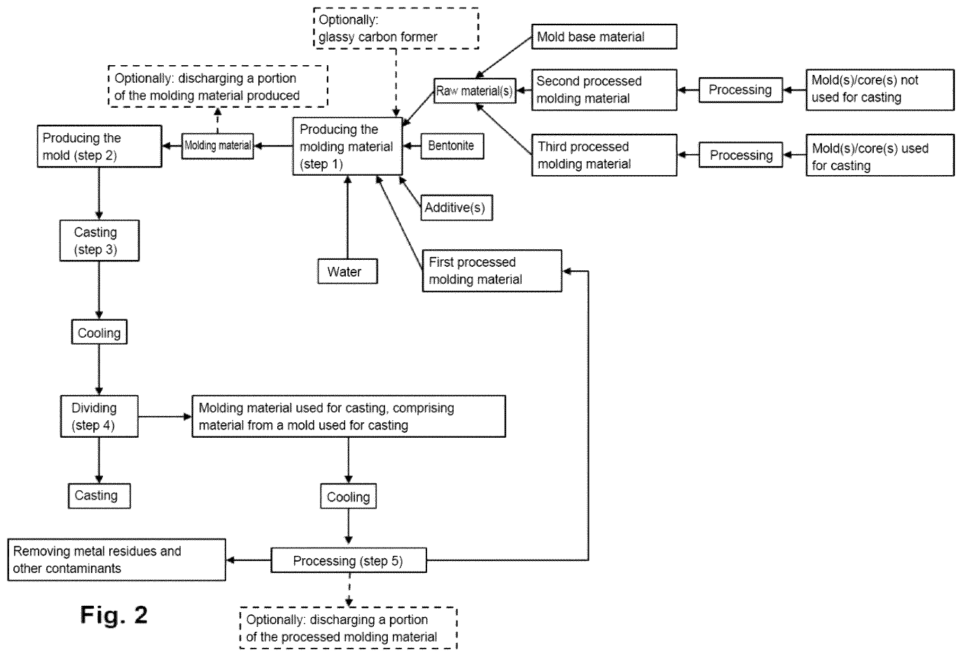

In the method of the invention, an earlier loop and a later loop, and preferably all loops, of the method of the invention preferably comprise the following steps (cf. FIG. 2, the further features of which are not supposed to have any limiting effect):
(Step 1) producing the molding material, i.e. producing a molding material comprising
   (i) first processed molding material produced by processing the molding material used for casting that results from an earlier loop of the molding material cycle, as defined above
   and
   (ii) aggregates as defined above
(Step 2) producing the mold, i.e. producing a smectite-containing clay-bound mold from the molding material produced in step (1)
(Step 3) casting, i.e. producing a casting by casting in the mold produced in step (2)
(Step 4) dividing, i.e. dividing the casting produced in step (3) from the mold, resulting in a molding material that has been used for casting
(Step 5) processing molding material that has been used for casting, i.e. processing the molding material used for casting from step (4), so as to obtain a first processed molding material for production of a new molding material in step (1) of a later loop, and, if necessary, discharging a portion of the molding material used for casting, so as to result in discharged molding material.

If there has not already been discharge of some of the molding material used for casting in the course of processing in step (5), in order to keep the mass of the molding material being cycled constant, some of the molding material produced in step (1) of the next cycle is discharged, so as to result in discharged molding material.

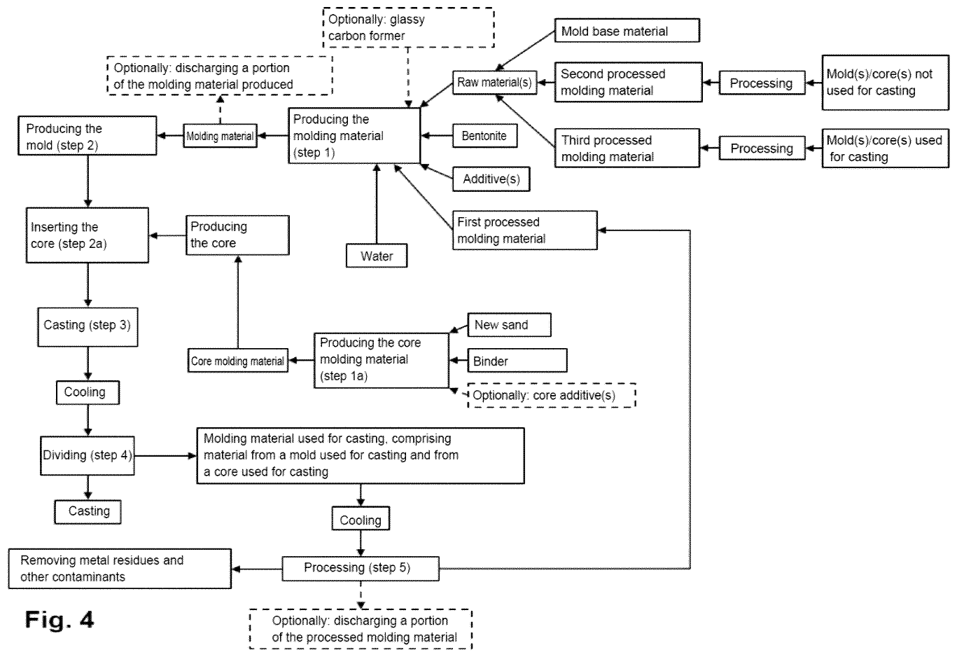

In a specific embodiment of the method of the invention, an earlier loop and a later loop, and preferably all loops, of the method of the invention preferably comprise the following steps (cf. FIG. 4, the further features of which are not supposed to have any limiting effect):
(Step 1) producing the molding material, i.e. producing a molding material comprising
   (i) processed molding material produced by processing the molding material used for casting that results from an earlier loop of the molding material cycle, as defined above and
   (ii) aggregates as defined above
(Step 1a) producing the core molding material, i.e. producing or providing a molding material for producing at least one core, where the molding material contains an inorganic binder, preferably a waterglass-containing binder
(Step 2) producing the mold, i.e. producing a smectite-containing clay-bound mold from the molding material produced in step (1)
(Step 2a) producing the core, i.e. producing of at least one core and inserting at least one core into the mold produced in step (2)
(Step 3) casting, i.e. producing a casting by casting with the mold produced in step (2) with the at least one core inserted in step (2a),
(Step 4) dividing, i.e. dividing the casting produced in step (3) from the mold and the at least one core, resulting in a molding material used for casting that contains material from the mold used for casting and from the core used for casting
(Step 5) processing, i.e. processing the molding material that has been used for casting from step (4), so as to obtain a first processed molding material for production of a new molding material in step (1) of a later loop, and optionally discharging a portion of the molding material used for casting so as to result in discharged molding material.

If a portion of the molding material used for casting has not already been discharged in the course of processing in step (5), in order to keep the mass of the cycled molding material constant, a portion of the molding material produced in step (1) of the next loop is discharged so as to result in discharged molding material.

It is preferable in particular cases that one or more or all cycles of the molding material cycle include further steps, and/or individual steps among those mentioned above have further features. Details of this will be apparent from the following description, and from the appended claims and drawings.

In the production of the molding material, in particular in step (1) of the molding material cycle, the processed molding material and the aggregate are preferably mixed. The aggregates preferably also comprise water.

The mold is preferably cooled together with the casting and—if present—the at least one core prior to division in step (4).

The molding material used for casting is preferably cooled prior to processing.

The processing regularly comprises substantial removal of metal residues and other contaminants, for example contaminants by auxiliary products from the casting process (core marks, feeder residues, etc.) and comminuting of the molding material used for casting (grain singularization).

The thermal, mechanical and possibly chemical stress gives rise to wear products, for example sand fines, inactive clay fractions, decomposition products of the additives and/or of the glassy carbon formers, or reaction products of core binders, and oolitized grains of the mold base material.

In order that such wear products do not accumulate in the molding material cycle and/or the molding material properties are not adversely affected, and/or the required active proportions of the binder (smectite-containing clay) and of the additive to be used in accordance with the invention do not fall to too low a level, aggregates are added to the molding material in a respective subsequent loop, especially in step (1), in the production of the molding material, i.e. the processed molding material is refreshed by the aggregates. In order to keep the mass of the molding material in the cycle constant, a corresponding amount of molding material is discharged from the molding material cycle. This can be done prior to refreshing by means of the aggregates (i.e. in particular in step (5)), or after the refreshing by means of the aggregates, i.e. after the producing of the molding material in the later loop. In the latter case, the amount of aggregates added is kept as small as possible.

In some cases, therefore, step (5) comprises the necessary discharge of molding material that has been used for casting in the same amount as that used for refreshing with aggregates comprising the additive to be used in accordance with the invention in step (1) of the next loop; it is thus possible to achieve a uniform profile of properties.

Preferably, in step (5), 0.5% by weight to 20% by weight, preferably 2% by weight to 15% by weight, more preferably 5% by weight to 10% by weight, of the molding material that has been used for casting is discharged (sand discharge) and, in step (1) of the subsequent loop, a corresponding amount of aggregates is added in order to keep the mass of the cycled molding material constant.

If a portion of the molding material used for casting has not already been discharged in step (5), in order to keep the mass of the cycled molding material constant, 0.5% by weight to 20% by weight, preferably 2% by weight to 15% by weight, more preferably 5% by weight to 10% by weight, of the molding material produced in step (1) is discharged.

The molding material discharged in the course of processing in step (5) preferably meets the requirements for landfill class DK I in accordance with Annex 3 of the German Ordinance on Landfills and Long-Term Disposal (Deponieverordnung—DepV) of Apr. 27, 2009.

Preferably, the molding material cycle to which the method of the invention relates comprises at least 10 loops, preferably at least 15 loops, more preferably at least 30 loops.

The additive to be used in accordance with the invention (as defined above) is preferably free-flowing and/or pourable. The additive is preferably in the form of a powder or a granular material. The additive is more preferably in the form of particles having a grain size of 20 μm to 200 μm, determined by laser granulometry.

The proportion of dehydratable inorganic compounds that eliminate water at a temperature of 150° C. or more is preferably 1% to 100%, based on the total mass of the additive as defined above. The proportion of dehydratable inorganic compounds that eliminate water at a temperature of 150° C. or more is more preferably 20% to 100%, based on the total mass of the additive as defined above. The proportion of dehydratable inorganic compounds that eliminate water at a temperature of 150° C. or more is most preferably 30% to 100%, based on the total mass of the additive as defined above. The proportion of dehydratable inorganic compounds that eliminate water at a temperature of 150° C. or more is especially preferably 50% to 100%, based on the total mass of the additive as defined above.

The additive preferably contains aluminum hydroxide, where the aluminum hydroxide present in the additive may have a water content in the range from 0.01% to 20%, preferably 0.01% to 12%. Particular preference is given to aluminum hydroxides with a water content of below 1% (i.e. a water content of less than 1%), ascertained by thermogravimetric analysis in the temperature range up to 105° C. There is no need for any particular resource expenditure for the drying of the aluminum hydroxide.

In the additive, aluminum hydroxide may be present in a mixture with iron oxide and/or iron hydroxide, where the proportion of aluminum hydroxide is greater than 40%, based on the total mass of aluminum hydroxide, iron oxide and/or iron hydroxide.

The additive to be used in accordance with the invention preferably has a pH in the range from 7 to 14, ascertained in accordance with DIN 19747:2009-07 (sample preparation), DIN EN 12457-1:2003-01 (leaching) and DIN EN ISO 10523:2012-04 (determination of the pH).

The additive to be used in accordance with the invention preferably contains one or more dehydratable inorganic compounds that eliminate water in a temperature range from 150° C. to 850° C.

Preferably, the total proportion of elements from the group consisting of Pb, Cd, Cr, Co, Cu, Mo, Ni, Hg, Se, Zn, P, As, F, Br and Cl is 1% by weight or less, preferably 0.5% by weight or less, more preferably 0.1% by weight, most preferably 0.05% by weight, based on the total mass of the additive.

When producing the molding material, the sequence in which the individual components are combined is flexible.

For example, the aggregates can be provided as a mixture.

Alternatively, the additive and smectite-containing clay aggregates can be provided as a mixture, and the other aggregates separately. This approach is consistent with the currently customary provision of glossy carbon formers in a prepared mixture with smectite-containing clays. It is thus possible to continue to use existing apparatuses for storage and dosing in the foundry.

Alternatively, the additive can be provided separately from the other aggregates.

Alternatively, the additive and optionally the smectite-containing clay, or a premix of additive and smectite-containing clay, can be first mixed with the first processed molding material, and then further raw materials are added as described above.

Preferably, the total mass of the raw materials from the group consisting of
mold base material,
second processed molding material produced by processing molding material from molds that have not been used for casting and/or cores and/or parts thereof,
third processed molding material produced by processing molds used for casting outside the molding material cycle and/or cores and/or parts thereof,
   is 0.5% to 10% by weight, preferably 1% to 8% by weight, more preferably 1.5% to 7% by weight, based on the total mass of the molding material to be produced.

The mass of the smectite-containing clay introduced as aggregate is preferably 0.1% to 1.5% by weight, further preferably 0.3% to 1.2% by weight, more preferably 0.5% to 1.0% by weight, based on the total mass of the molding material to be produced.

The total mass of the dehydratable inorganic compounds that are introduced with the additive (as defined above) as aggregate and eliminate water at a temperature of 150° C. or more is 0.1% to 1% by weight, preferably 0.3% to 0.8% by weight, more preferably 0.4% to 0.7% by weight, based on the total mass of the molding material to be produced.

The smectite-containing clay to be used in the method of the invention is preferably bentonite, more preferably selected from the group consisting of sodium bentonite and calcium bentonite and mixtures thereof.

The mold base material is preferably selected from the group consisting of quartz sand, olivine sand, chromite sand, zirconium sand, synthetically produced ceramic sands, and mixtures of these sands. Typically, a clay-bound mold contains at least 40% sand, preferably more than 50% sand, more preferably more than 60% sand and most preferably more than 70% sand.

The method is preferably designed such that at least 90% by weight of the molding material, on casting, is subjected to a temperature of at most 1000° C. At temperatures above 1000° C., aluminum hydroxide is irreversibly converted to corundum (α-aluminum hydroxide), which cannot be converted back to aluminum hydroxide in a later loop by adding water and is therefore no longer capable of acting as an additive to be used in accordance with the invention as defined above.

It is therefore preferable that less than 50% by weight, preferably less than 25% by weight and more preferably less than 10% by weight of the Al₂O₃ present in the molding material is in the form of corundum.

Preferably, the molding material produced in the later loop of the method of the invention has the following parameters:
compressibility in the range from 25% to 55%, determined in accordance with VDG Merkblatt P37 (April 1997) and/or
green compressive strength in the range from 8 N/cm² to 35 N/cm², determined in accordance with VDG Merkblatt P38 (May 1997) and/or
wet tensile strength of 0.10 N/cm² to 0.50 N/cm², determined in accordance with VDG Merkblatt P38 (May 1997) and/or
gas permeability of 70 to 200, determined in accordance with BDG-Richtlinie P41 (October 2013) and/or
an active clay content of 6% to 14%, determined by the methylene blue method according to VDG Merkblatt P035 (October 1999) and/or
flowability of 20% to 90%, determined in accordance with Morek Multiserw, technical documentation for model LUA-2e ram device with electric drive, page 7.

More preferably, the molding material produced in the later loop of the method of the invention has the following parameters:
compactability in the range from 30% to 50%, determined in accordance with VDG-Merkblatt P37 (April 1997) and/or
green compressive strength in the range from 10 N/cm² to 28 N/cm², determined in accordance with VDG-Merkblatt P38 (May 1997) and/or
wet tensile strength of 0.20 N/cm² to 0.45 N/cm², determined in accordance with VDG Merkblatt P38 (May 1997) and/or
gas permeability of 90 to 160, determined in accordance with BDG-Richtlinie P41 (October 2013) and/or
an active clay content of 6% to 14%, determined by the methylene blue method according to VDG Merkblatt P035 (October 1999) and/or
flowability of 50% to 90%, determined in accordance with Morek Multiserw, technical documentation for model LUA-2e ram device with electric drive, page 7.

All the abovementioned parameters of the molding material are preferably in the abovementioned preferred ranges, especially in the abovementioned particularly preferred ranges.

A further aspect of the present disclosure relates to the use of the additive defined above in a method of the invention as defined above. The above embodiments are applicable with regard to additives to be used with preference and preferred process designs.

The invention will be described in detail hereinafter with reference to the attached schematic figures. The figures show:

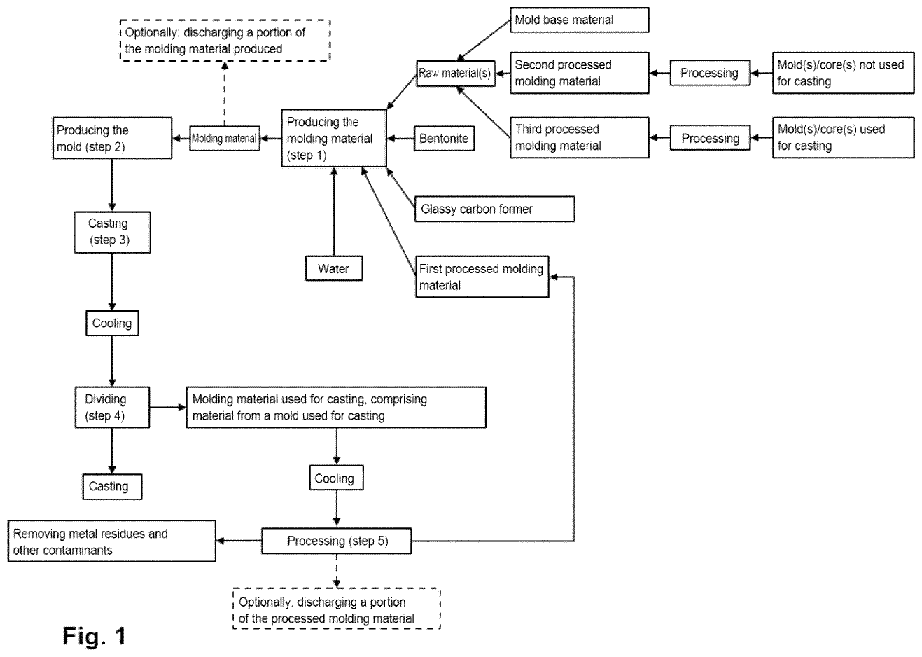

FIG. 1 a molding material cycle (casting in coreless mold) according to the prior art

FIG. 2 a molding material cycle (casting in coreless mold) by the method of the invention

FIG. 3 a molding material cycle (casting in mold with core) according to the prior art

FIG. 4 a molding material cycle (casting in mold with core) by the method of the invention

One loop of a molding material cycle wherein the mold used for casting in step (3) contains no inserted core, according to FIG. 1 and FIG. 2, comprises at least steps (1) to (5) as defined above.

In step (1), a molding material is produced, comprising
(i) first processed molding material that is produced by processing the molding material used for casting and resulting from an earlier loop of the molding material cycle and that does not include any material from cores used for casting,
and
(ii) aggregates.

The aggregates comprise
one or more raw materials from the group consisting of
   fresh mold base material (new sand),
   and at least one processed molding material from the group consisting of
      second processed molding material produced by processing molds that have not been used for casting and/or cores and/or parts thereof,
      third processed molding material produced by processing molds and/or cores and/or parts thereof that have been produced and used for casting outside the molding material cycle shown in FIG. 1 and FIG. 2,
smectite-containing clay, preferably bentonite
water.

The second processed molding material here contains material from molds that have not been used for casting, cores and/or parts thereof, where the molds and/or cores have been produced with an inorganic binder, and/or the third processed molding material contains material from molds that have been used for casting, cores and/or parts thereof, where the molds and/or cores have been produced with an inorganic binder. Preferably, the inorganic binder contains waterglass, in particular waterglass hardened thermally or by sparging with CO₂. The material from the molds and core that have been used for casting comprises reaction products of the inorganic binder formed in the course of casting.

The processed molding materials preferably do not contain any organic binders, and preferably do not contain any organic material at all. The processed molding materials preferably do not contain any carbon or any carbon carrier.

In the noninventive method (FIG. 1), at least one glassy carbon former is added as a further aggregate in step (1) in the course of production of the molding material.

In the inventive method (FIG. 2), the above-defined additive is added as a further aggregate in step (1) in the production of the molding material. The additive preferably contains or consists of aluminum trihydroxide.

In step (2), the molding material produced in step (1) is used to produce a smectite-containing clay-bound mold.

In step (3), a casting is produced by casting with the mold produced in step (2). The mold does not contain any inserted cores.

In step (4), the casting produced in step (3) is divided from the mold, resulting in a molding material used for casting and comprising material from a mold used for casting, but no material from cores used for casting. Prior to division in step (4), the mold is preferably cooled down together with the casting.

In step (5), the molding material that has been used for casting from step (4) is processed so as to obtain a first processed molding material for production of a new molding material in step (1) of a later loop, in particular the next loop. Prior to processing in step (5), the molding material used for casting is preferably cooled down. In the course of processing, a portion of the molding material used for casting may be discharged, so as to result in a discharged molding material.

If a portion of the molding material used for casting has not already been discharged in the course of processing in step (5), in order to keep the mass of the cycled molding material constant, a portion of the molding material produced in step (1) of the next loop is discharged so as to result in discharged molding material.

In step (1) of a later loop, in particular the next loop, the first processed molding material that results from step (5) of the earlier loop, in particular the previous loop, is used for production of a new molding material as described above.

A loop of a molding material cycle wherein the mold used for casting in step (3) contains at least one inserted core, according to FIG. 3 and FIG. 4, comprises at least steps (1), (1a), (2), (2a), (3), (4) and (5) as defined above.

In step (1), a molding material is produced, comprising
(i) first processed molding material which has been produced by processing the molding material used for casting that results from an earlier loop of the molding material cycle and which comprises material from cores used for casting that has been produced with an inorganic binder
and
(ii) aggregates.

The aggregates comprise
one or more raw materials from the group consisting of
   fresh mold base material (new sand),
   and at least one processed molding material from the group consisting of
      second processed molding material produced by processing molds that have not been used for casting and/or cores and/or parts thereof,
      third processed molding material produced by processing molds and/or cores and/or parts thereof that have been produced and used for casting outside the molding material cycle shown in FIG. 3 and FIG. 4,
smectite-containing clay, preferably bentonite
water.

In the noninventive method (FIG. 3), at least one glassy carbon former is added as a further aggregate in step (1) in the course of production of the molding material.

In the inventive method (FIG. 4), the above-defined additive is added as a further aggregate in step (1) in the production of the molding material. The additive preferably contains or consists of aluminum trihydroxide.

The processed molding materials preferably do not contain any organic binders, and preferably do not contain any organic material at all. The processed molding materials preferably do not contain any carbon or any carbon carrier.

In step (1a), a molding material for producing at least one core (core molding material) is produced or provided. This molding material includes a mold base material, an inorganic binder and optionally additives. Suitable additives for molding materials for production of cores are known from the prior art. The binder is a standard inorganic binder, e.g. a waterglass-containing binder.

In step (2), the molding material produced in step (1) is used to produce a smectite-containing clay-bound mold.

In step (2a), the molding material (core molding material) produced or provided in step (1a) is used to produce at least one core, which is inserted into the mold produced in step (2).

In step (3), a casting is produced by casting with the mold that is produced in step (2) and contains at least one inserted core.

In step (4), the casting produced in step (3) is divided from the mold, resulting in a molding material that is used for casting and comprises material from the mold used for casting and material from the core used for casting. The material from the core used for casting comprises reaction products of the binder that are formed on casting.

Prior to division in step (4), the mold is preferably cooled down together with the casting.

In step (5), the molding material that has been used for casting from step (4) is processed so as to obtain a first processed molding material for production of a new molding material in step (1) of a later loop, in particular the next loop. Prior to processing in step (5), the molding material used for casting is preferably cooled down. In the course of processing, a portion of the molding material used for casting may be discharged, so as to result in a discharged molding material.

If a portion of the molding material used for casting has not already been discharged in the course of processing in step (5), in order to keep the mass of the cycled molding material constant, a portion of the molding material produced in step (1) of the next loop is discharged so as to result in discharged molding material.

In step (1) of a later loop, in particular the next loop, the first processed molding material that results from step (5) of the earlier loop, in particular the previous loop, is used for production of a new molding material as described above.

The invention is further described hereinafter by nonlimiting examples.

### 0. Test Methods and Molding Materials

### 0.1 Test Methods

The test methods (measurement methods) that follow were used (table 1)

TABLE 1
Measurement methods used

| Parameter/property | Measurement method/definition |
|---|---|
| Compactability (CPB), bulk | VDG-Merkblatt [information sheet from the German |
| density | society of foundry experts] P 37 (Apr. 1997) |
| Green compressive strength | VDG-Merkblatt P 38_Festigkeiten (May 1997) |
| (GCS) | VDG-Merkblatt P 69_Bindemittelprüfung (Oct. 1999) |
| Splitting resistance | 1 Dry compressive strength is defined by P69 after thermal |
| Shear strength | stress of the test specimen at 150° C. for 3 hours (h). In |
| Wet tensile strength (WTS) | addition, tests were carried out with the following times and |
| Dry compressive strength | temperatures: thermal stress at 350° C. for 1.5 h, thermal |
| (DCS)¹⁾ | stress at 450° C. for 45 minutes (min) and thermal stress at |
| | 750° C. for 30 min. |
| Flowability | determined in accordance with Morek Multiserw, technical |
| | documentation for model LUA-2e ram device with electric |
| | drive, page 7. |
| Gas permeability (gas | BDG-Richtlinie [guideline procedure from the German |
| permeability index) | foundry industry federation] P 41 (Oct. 2013) |
| Water content | VDG-Merkblatt P 32_Wassergehalt Formstoff (Apr. 1997) |
| | VDG-Merkblatt P 69_Bindemittelprüfung (Oct. 1999) |
| Active clay content | VDG-Merkblatt P 35_Methylenblau (Oct. 1999) |
| (proportion of bindable clay, | VDG-Merkblatt P 69_Bindemittelprüfung (Oct. 1999) |
| methylene blue value) | |
| Ignition loss | VDG-Merkblatt P 33 (Apr. 1997) |
| Carbon, nitrogen and sulfur | Elemental analysis |
| contents (C, N, S) | The elemental analysis of elements C, N and S is effected |
| | by the method of catalytic tube combustion at 1140° C. |
| | Extrinsic gases are separated off, and the measurement |
| | components are separated and detected by thermal |
| | conductivity detector. This is done using a VARIO |
| | MAX CUBE elemental analyzer (from Elementar |
| | Analysensysteme GmbH) with application software. |
| Surface roughness, | DIN EN ISO 4287 (Jul. 2010) |
| roughness depth (Rz) | The castings are blasted prior to measurement of |
| | roughness. |
| | Blasting system: model SMG160KP from MHG |
| | Strahlanlagen GmbH |
| | Abrasive: HG 24 angular chilled cast iron abrasive, 0.60- |
| | 1.00 mm, from Metalltechnik Schmidt GmbH & Co. KG |
| | Castings received with fin model setup: 15 seconds on |
| | each fin surface at jet pressure 600 kPa (6.0 bar) (castings |
| | obtained with molds according to the fin model setup) |
| | Castings received with sleeve model setup: 5 seconds on |
| | each fin surface at jet pressure 450 kPa (4.5 bar) (castings |
| | obtained with molds according to the sleeve model setup) |
| AFS number | VDG-Merkblatt P 34 (Oct. 1999) |
| Average grain size | |
| Sludge content | |
| Degree of uniformity | |

Sleeve and fin model setups are produced as described in (https://www.researchdisclosure.com/data-base/RD705032) and used in the tests that follow.

### 0.2 Materials Used

All figures for raw material dosages relate to the pure raw material in each case, i.e. as dry materials, meaning without any moisture or hydrate water present.

In the course of the studies, a molding material (also referred to hereinafter as starting molding material) from the conditioned molding material cycle system of a brake disk foundry was used as starting material for tests for conversion of molding material cycle systems containing glassy carbon formers. The molding material can be described by the following data (table 2).

TABLE 2
Parameters of the starting molding material

| | Molding material from |
|---|---|
| | the conditioned molding |
| | material cycle system |
| Parameter | a brake disk foundry |
| Moisture content % | 3.0 |
| (i.e. water content, cf. table 1) | |
| Ignition loss (900° C.) % | 3.5 |
| Active clay content % | 5.2 |
| C % | 2.5 |
| N % | 0.05 |
| S % | 0.02 |
| AFS number | 52 |
| Average grain size mm | 0.30 |
| Sludge content % | 10.1 |
| Compactability % | 45 |
| Test specimen weight g | 148 |
| Green compressive strength N/cm² | 18.2 |
| Wet tensile strength N/cm² | 0.31 |
| Gas permeability | 152 |

In the course of the experimental studies, processed molding materials from core sands were used (second processed molding material as defined above). For this purpose, cores were produced with an organic binder or an inorganic binder and then grated using a Webac circular vibrating screen.

The starting material for a molding material produced with an organic binder is cores that are produced by the coldbox process and are produced with the Biocure 8568P1/Silcure 8431 P2 binder sold by Htittenes-Albertus Chemische Werke GmbH in an LL20 core shooter from Laempe. For this purpose, an H32 type sand from Quarzwerke was used, and a dosage of 0.7 part by weight of each binder component to 100 parts by weight of sand. The cores were produced with a shooting pressure of 450 kPa (4.5 bar) and a shooting time of 1.5 seconds and then cured by passing through 10 g of dimethylpropylamine (N,N-dimethylpropylamine, GH6 catalyst from Huttenes-Albertus Chemische Werke GmbH) at a sparging pressure of 200 kPa (2 bar) for 45 s.

The starting material for a molding material produced with an inorganic binder is cores that are produced with the Cordis 9477/Anorgit 9476 binder system sold by Huttenes-Albertus Chemische Werke GmbH on an LL20 core shooter from Laempe. For this purpose, an H32 type sand from Quarzwerke was used, and a dosage of 2.2 parts by weight of Cordis 9477 and 1.15 parts by weight of Anorgit 9476 of each binder component to 100 parts by weight of sand. The cores are produced with a shooting pressure of 450 kPa (4.5 bar) and a shooting time of 1.5 seconds in a corebox at a controlled temperature of 180° C. The cores are cured by a flow of hot air at 120° C. with a sparging pressure of 200 kPa (2 bar) for 1 minute.

The cores are grated with a circular vibrating screen (circular vibrating screen—175056 pilot plant, from Webac). The resultant molding material has the properties shown in table 3.

TABLE 3
Parameters of the processed molding
materials made from core sands

| | Molding material | Molding material |
|---|---|---|
| | made from | made from inorgan- |
| | coldbox cores | ically bound cores |
| Moisture content % | 0.28 | 0.1 |
| (i.e. water content, cf. table 1) | | |
| Ignition loss (900° C.) % | 1.2 | 0.2 |
| C % | 1.04 | 0.06 |
| N % | 0.8 | <NG |
| S % | <NG | 0.01 |
| AFS number | 47 | 50 |
| Sludge % | 0.2 | 0.5 |

The abbreviation NG indicates that the measured values are below the detection limit

Starting material for cores that do not break down under the experimental conditions (i.e. cores that do not break down in the course of division (step (4)), see below, point 3, experiment series A) is quartz sand of the HAP 0.20/0.315/0.40 type from HA Polska and an inorganic binder consisting of waterglass of the Steinex 48/50 type, Huttenes-Albertus Chemische Werke GmbH, in combination with Silica Fume Q1-Plus from RW Silicium. 100 parts by weight of quartz sand was mixed with 1.1 parts by weight of Silica Fume Q1-Plus and 3.4 parts by weight of Steinex 48/50 and shaped to a core in a bulk corebox. Subsequently, the core was sparged with hot CO₂ at 100° C. at sparging pressure 150 kPa (1.5 bar) for 60 s in a Morek labor-atory core shooting machine and hence cured.

### 1. Screening Tests for Identification of Suitable Additives

6 kg of quartz sand (H32, from Quarzwerke) are mixed in a mixer (LM-2e pan mill mixer, from Morek MULTISERW) with 120 ml of water at a speed of 40 rpm for 2 min. Then 0.48 kg of bentonite (dry weight) (Natroben 25F, Clariant) and 0.30 kg of additive (dry weight) are added and mixed at a speed of 40 rpm for 7 min. The mixture obtained in this way is screened manually through a screen with a mesh size of 3 mm, and then compactability (CPB) (tester type: PVG; ID No: 1501, year of manufacture: 2000) is determined. If CPB is greater than 46.0%, the mixture is screened again and the CPB measurement is repeated. This process is repeated until CPB is below 46.0%. If CPB is less than 44.0%, 7-12 ml of water is added, followed by mixing again for 1 min, then screening and CPB measurement are repeated. The addition of water is repeated until the CPB is above 44.0%.

As a reference for the molding material properties, 3 different mixtures with glassy carbon former according to the prior art are used:
1) a commercially available premix of 25% glassy carbon former (“sea coal”) and 75% sodium bentonite (NEMIR 2575) from HA Italia S.p.A.
2) 5 parts by weight of ground coke (metallurgical coke) from LuxCarbon GmbH as glassy carbon former and 8 parts by weight of bentonite (Natroben 25F, Clariant)
3) 5 parts by weight of Carboluxon 100/P from Huttenes-Albertus France as commercially available glassy carbon former and 8 parts by weight of bentonite (Natroben 25F, Clariant).

In addition to the molding material indices, casting quality is also a crucial criterion for selection of suitable additives. For this purpose, i.e. for verification of casting quality, casting is effected by means of the sleeve model setup described in (https://www.researchdisclosure.com/database/RD705032), i.e. molds produced according to the sleeve model setup as described in (https://www.researchdisclosure.com/data-base/RD705032) are used for casting, then the castings are blasted and surface roughness is measured in accordance with DIN EN ISO 4287 (R_ISO). 2 castings in each case are examined; this involves exam-ining the surfaces with a small, medium and large separation of the fins that are in a star-shaped arrange-ment 3 times in each case with a Mitutoyo SJ-500P surface measuring instrument over a measuring dis-tance of 8 mm in each case. There is no consistent trend in terms of the spacing of the fins relative to one another and surface roughness, and so the average over all measurements conducted is used to simplify evaluation. This shows that the surface roughness in all the castings obtained is in a range that permits commercial use.

### 1.1 Different Aluminum Hydroxide and Magnesium Hydroxide Types as Additives

For the examination of aluminum hydroxides, Al(OH)₃ of the SH500 type (SH500 nuance-00, Alteo) and SH950 type (SH950 nuance-00, Alteo) are used.

For the examination of magnesium hydroxides, type 1 brucite, type 2 brucite and type 3 brucite from Ziegler & Co. GmbH are used (table 4, all values according to the Ziegler technical data sheet of 10/2020).

TABLE 4
Parameters of the brucite types used as additive

| | | |
|---|---|---|
| Type 1 | Type 2 | Type 3 |
| brucite | brucite | brucite |

Chemical analysis

| | | | |
|---|---|---|---|
| MgO | 59.8% | 63.2% | 60.2% |
| CaO | 3.3% | 0.2% | 1.3% |
| SiO₂ | 5.6% | 7.3% | 7.1% |
| Fe₂O₃ | 0.5% | 0.7% | 0.7% |
| Ignition loss | 29.7% | 28.5% | 28.2% |

Physical properties

| | | | |
|---|---|---|---|
| Moisture content | <1% | <1% | <1% |
| (i.e. water content, | | | |
| cf. table 1) | | | |
| Density | 600 g/l | 590 g/l | 580 g/l |

Grain size (Cilas 920 laser granulometry) [μm]

| | | | |
|---|---|---|---|
| D98 | 53.0 | 52.9 | 53.5 |
| D90 | 37.4 | 37.4 | 38.3 |
| D50 | 9.6 | 9.7 | 9.9 |
| D10 | 1.5 | 1.6 | 1.5 |

Table 5 shows the molding material properties and the roughness of the casting with use of various hydroxides and glassy carbon formers 1) to 3) that are used as reference. Dry compressive strengths (DCS) of <35 N/cm² and water contents of <2.8% are regarded as particularly positive, while dry compressive strengths of >50 N/cm² are assessed as negative, as are water contents of >3.2%. Hydroxides, in particular aluminum hydroxide Al(OH)₃ and magnesium hydroxide Mg(OH)₂, enable the production of molds and show good molding material indices (cf. table 5).

TABLE 5
Molding material properties and roughness of the casting with
use of various hydroxides or glassy carbon formers as additive

| | | Refer- | | | | | | |
|---|---|---|---|---|---|---|---|---|
| | | ence 2) | Refer- | Alumi- | Alumi- | | | |
| | Refer- | ground | ence 3) | num | num | | | |
| | ence 1) | coke | Carbo- | trihydro- | trihydro- | | | |
| | NEMIR | (Lux- | luxon | xide | xide | Type 1 | Type 2 | Type 3 |
| | 2575 | Carbon) | 100/P | SH 500 | SH 950 | brucite | brucite | brucite |
| Compactability [%] | 45.6 | 44.1 | 44.1 | 45.1 | 45.4 | 45.5 | 44.6 | 44.5 |
| Weight of CPB test specimen [g] | 159.2 | 168.4 | 162.2 | 162.8 | 161.0 | 164.1 | 168.6 | 168.5 |
| (test specimen for determination of | | | | | | | | |
| compactability, cf. Merkblatt P 37) | | | | | | | | |
| Bulk density [g/cm³] | 0.811 | 0.858 | 0.826 | 0.829 | 0.820 | 0.836 | 0.859 | 0.858 |
| Test specimen weight [g] (test | 152 | 155 | 147 | 152 | 152 | 151 | 152 | 153 |
| specimen for determination of green | | | | | | | | |
| compressive strength, shear strength | | | | | | | | |
| and splitting resistance) | | | | | | | | |
| Green compressive strength [N/cm²] | 16.87 | 17.53 | 17.84 | 16.90 | 16.75 | 20.62 | 19.68 | 20.52 |
| Shear strength (green shear | 3.55 | 3.89 | 3.83 | 3.54 | 3.51 | 4.58 | 4.60 | 4.98 |
| strength) [N/cm²] | | | | | | | | |
| Splitting resistance (green splitting | 2.97 | 3.02 | 3.28 | 2.94 | 2.84 | 3.78 | 3.57 | 3.74 |
| resistance) [N/cm²] | | | | | | | | |
| Wet tensile strength [N/cm²] | 0.49 | 0.49 | 0.46 | 0.49 | 0.49 | 0.55 | 0.55 | 0.54 |
| Gas permeability index | 179 | 153 | 146 | 199 | 196 | 208 | 195 | 199 |
| Water content [wt %] | 2.79 | 3.05 | 3.15 | 2.78 | 2.63 | 3.05 | 3.00 | 3.04 |
| DCS 150° C./3 h [N/cm²] | 29.9 | 46.3 | 32.3 | 36.6 | 32.1 | 53.9 | 48.2 | 40.4 |
| DCS 350° C./1.5 h [N/cm²] | 22.6 | 43.1 | 15.3 | 28.3 | 21.5 | 45.3 | 43.8 | 43.2 |
| DCS 550° C./45 min [N/cm²] | 23.2 | 41.8 | 19.5 | 34.9 | 22.1 | 43.0 | 40.0 | 34.2 |
| DCS 750° C./30 min [N/cm²] | 6.6 | 21.5 | 8.3 | 22.1 | 11.0 | 23.4 | 23.2 | 23.2 |
| Surface roughness of the casting [μm] | 102 | 150 | 73 | | 150 | | | 151 |

1.2 Investigation of Aluminum Hydroxide Al(OH)₃ as Additive with Addition of Glassy Carbon Formers

The good values for hydroxides, in particular aluminum hydroxide Al(OH)₃, can be further improved by the addition of glassy carbon formers such as Carboluxon 100/P; see table 6. In particular, the surface roughness of the castings is reduced by the use of Carboluxon 100/P, although the values found when using pure aluminum hydroxide are also adequate.

TABLE 6
Molding material properties and roughness of the casting when using
Al(OH)₃ SH 950 as additive with addition of Carboluxon 100/P glassy carbon former

| | | | Al(OH)₃ | Al(OH)₃ | Al(OH)₃ |
|---|---|---|---|---|---|
| | | | 90%/ | 70%/ | 50%/ |
| | Reference | Reference | Carboluxon | Carboluxon | Carboluxon |
| | aluminum | 3) | 100/P | 100/P | 100/P |
| | trihydroxide | Carboluxon | (charcoal) | (charcoal) | (charcoal) |
| | SH 950 | 100/P | 10% | 30% | 50% |
| Compactability [%] | 45.4 | 44.1 | 44.5 | 45.2 | 45.6 |
| Weight of CPB test specimen [g] (test | 161.0 | 162.2 | 164.3 | 161.4 | 159.5 |
| specimen for determination of compactability, | | | | | |
| cf. Merkblatt P 37) | | | | | |
| Bulk density [g/cm³] | 0.820 | 0.826 | 0.837 | 0.822 | 0.812 |
| Test specimen weight [g] (test specimen | 152 | 147 | 150 | 150 | 150 |
| for determination of green compressive | | | | | |
| strength, shear strength and splitting | | | | | |
| resistance) | | | | | |
| Green compressive strength [N/cm²] | 16.75 | 17.84 | 16.45 | 16.91 | 16.65 |
| Shear strength (green shear strength) | 3.51 | 3.83 | 3.63 | 3.72 | 3.56 |
| [N/cm²] | | | | | |
| Splitting resistance (green splitting | 2.84 | 3.28 | 2.61 | 2.67 | 2.52 |
| resistance) [N/cm²] | | | | | |
| Wet tensile strength [N/cm²] | 0.49 | 0.46 | 0.48 | 0.49 | 0.48 |
| Gas permeability index | 196 | 146 | 180 | 165 | 151 |
| Water content [wt %] | 2.63 | 3.15 | 2.61 | 2.69 | 2.74 |
| DCS 150° C./3 h [N/cm²] | 32.1 | 32.3 | 24.9 | 29.0 | 26.8 |
| DCS 350° C./1.5 h [N/cm²] | 21.5 | 15.3 | 21.3 | 19.5 | 19.9 |
| DCS 550° C./45 min [N/cm²] | 22.1 | 19.5 | 14.7 | 16.9 | 15.4 |
| DCS 750° C./30 min [N/cm²] | 11.0 | 8.3 | 6.1 | 7.3 | 9.5 |
| Surface roughness of the casting [μm] | 150 | 73 | 150 | 116 | 83 |

### 1.3 Studies of Different Carbonates as Comarative Additives

While huntite (trade name UltraCarb 98, sourced from LKAB Minerals) cannot achieve sufficiently good molding material values, dolomite and manganese carbonate (sourced from TROPAG GmbH) show entirely acceptable molding material values (table 7).

The dolomites used were Bianco Zandobbio 0/50 micron from Ziegler and PE-DOL 90 from Possehl Erzkontor. Overall, the molding material indices are somewhat worse compared to those when using the hydroxides described above. The values nevertheless permit use ofthe materials as a substitute for conventional glassy carbon formers. However, carbonates have the disadvantage that they contain carbon.

TABLE 7
Molding material properties with use of different carbonates or glassy carbon formers as additive

| | Reference | Reference | Carboluxon | | Huntite: | | |
|---|---|---|---|---|---|---|---|
| | 1) | 2) ground | 100/P | | UltraCarb | Dolomite: | Dolomite: |
| | NEMIR | coke (Lux- | Reference | | D98 | PE-DOL | Bianco |
| | 2575 | Carbon) | 3) | MnCO³ | 53 μm | 90 | Zandobbio |
| Compactability [%] | 45.6 | 44.1 | 44.1 | 45.2 | 44.5 | 44.3 | 44.2 |
| Weight of CPB test specimen [g] | 159.2 | 168.4 | 162.2 | 163.0 | 169.1 | 164.9 | 165.9 |
| (test specimen for determination of | | | | | | | |
| compactability, cf. Merkblatt P 37) | | | | | | | |
| Bulk density [g/cm3] | 0.811 | 0.858 | 0.826 | 0.830 | 0.861 | 0.840 | 0.845 |
| Test specimen weight [g] (test specimen | 152 | 155 | 147 | 152 | 152 | 150 | 150 |
| for determination of green compressive | | | | | | | |
| strength, shear strength and splitting | | | | | | | |
| resistance) | | | | | | | |
| Green compressive strength [N/cm²] | 16.87 | 17.53 | 17.84 | 17.04 | 19.28 | 18.53 | 17.65 |
| Shear strength (green shear strength) | 3.55 | 3.89 | 3.83 | 4.11 | 4.90 | 4.32 | 3.88 |
| [N/cm²] | | | | | | | |
| Splitting resistance (green splitting | 2.97 | 3.02 | 3.28 | 3.24 | 3.76 | 3.23 | 3.01 |
| resistance) [N/cm²] | | | | | | | |
| Wet tensile strength [N/cm²] | 0.49 | 0.49 | 0.46 | 0.49 | 0.55 | 0.53 | 0.53 |
| Gas permeability index | 179 | 153 | 146 | 224 | 205 | 229 | 233 |
| Water content [wt%] | 2.79 | 3.05 | 3.15 | 3.08 | 3.68 | 2.80 | 2.74 |
| DCS 150° C./3 h [N/cm²] | 29.9 | 46.3 | 32.3 | 47.9 | 72.4 | 40.1 | 43.3 |
| DCS 350° C./1.5 h [N/cm²] | 22.6 | 43.1 | 15.3 | 56.7 | 55.5 | 37.7 | 42.2 |
| DCS 550° C./45 min [N/cm²] | 23.2 | 41.8 | 19.5 | 37.7 | 60.5 | 38.8 | 38.0 |
| DCS 750° C./30 min [N/cm²] | 6.6 | 21.5 | 8.3 | 17.2 | 18.0 | 17.6 | 18.5 |

The molding material properties can be improved by mixing of the carbonates with hydroxides (Table 8). In this context, Mixmag is a 50%/50% mixture of brucite (93% Mg(OH)₂) with raw magnesite (92% MgCO₃), which was sourced from Possehl Erzkontor GmbH & Co. KG, and Dolomag is a 50%/50% mixture of brucite (93% Mg(OH)₂) and dolomite (95% CaMg(CO₃)₂), which was likewise sourced from Possehl Erzkontor.

TABLE 8
Molding material properties and roughness of the casting
with use of various carbonate-hydroxide mixtures

| | Reference | Comparison | Mixmag | Dolomag | Comparison | 50% |
|---|---|---|---|---|---|---|
| | 3) | 1) | (Mg(OH)₂ + | (brucite + | 2) | Al(OH)₃, |
| | Carboluxon | type 3 | MgCO₃) | dolomite) | Al(OH)₃ | 50% |
| | 100/P | brucite | 50:50 | 50:50 | SH 950 | MnCO³ |
| Compactability [%] | 44.1 | 44.5 | 45.8 | 45.2 | 45.4 | 45.7 |
| Weight of CPB test specimen [g] (test | 162.2 | 168.5 | 161.2 | 163.4 | 161.0 | 161.2 |
| specimen for determination of | | | | | | |
| compactability, cf. Merkblatt P 37) | | | | | | |
| Bulk density [g/cm3] | 0.826 | 0.858 | 0.821 | 0.832 | 0.820 | 0.821 |
| Test specimen weight [g] (test specimen for | 147 | 153 | 151 | 152 | 152 | 150 |
| determination of green compressive strength, | | | | | | |
| shear strength and splitting resistance) | | | | | | |
| Green compressive strength [N/cm²] | 17.84 | 20.52 | 18.71 | 19.08 | 16.75 | 16.79 |
| Shear strength (green shear strength) | 3.83 | 4.98 | 4.54 | 3.90 | 3.51 | 3.72 |
| [N/cm²] | | | | | | |
| Splitting resistance (green splitting | 3.28 | 3.74 | 3.42 | 3.22 | 2.84 | 2.77 |
| resistance) [N/cm²] | | | | | | |
| Wet tensile strength [N/cm²] | 0.46 | 0.54 | 0.61 | 0.54 | 0.49 | 0.48 |
| Gas permeability index | 146 | 199 | 216 | 214 | 196 | 192 |
| Water content [wt %] | 3.15 | 3.04 | 2.80 | 2.78 | 2.63 | 2.66 |
| DCS 150° C./3 h [N/cm²] | 32.3 | 40.4 | 37.9 | 46.7 | 32.1 | 31.7 |
| DCS 350° C./1.5 h [N/cm²] | 15.3 | 43.2 | 44.4 | 40.2 | 21.5 | 26.8 |
| DCS 550° C./45 min [N/cm²] | 19.5 | 34.2 | 32.1 | 37.1 | 22.1 | 22.4 |
| DCS 750° C./30 min [N/cm²] | 8.3 | 23.2 | 20.7 | 15.5 | 11.0 | 8.1 |
| Surface roughness of the casting [um] | | 151 | 175 | 180 | 150 | |

If a glassy carbon former according to the prior art such as Carboluxon 100/P is additionally added to a mixture of hydroxide and carbonate, the molding material values can be improved further (table 9).

TABLE 9
Molding material properties with use of various carbonate-hydroxide
mixtures with admixture of Carboluxon 100/P as glassy carbon former

| | | | Mixmag | Mixmag | Mixmag |
|---|---|---|---|---|---|
| | Reference. | | 90%/ | 70%/ | 50%/ |
| | 3) | Comparison | Carboluxon | Carboluxon | Carboluxon |
| | Carboluxon | 1) | 100/P | 100/P | 100/P |
| | 100/P | Mixmag | 10% | 30% | 50% |
| Compactability [%] | 44.1 | 45.8 | 44.1 | 45.6 | 45.0 |
| Weight of CPB test specimen [g] (test | 162.2 | 161.2 | 166.4 | 160.9 | 162.3 |
| specimen for determination of | | | | | |
| compactability, cf. Merkblatt P 37) | | | | | |
| Bulk density [g/cm³] | 0.826 | 0.821 | 0.847 | 0.819 | 0.827 |
| Test specimen weight [g] (test specimen | 147 | 151 | 150 | 150 | 150 |
| for determination of green compressive | | | | | |
| strength, shear strength and splitting | | | | | |
| resistance) | | | | | |
| Green compressive strength [N/cm²] | 17.84 | 18.71 | 19.54 | 18.49 | 18.69 |
| Shear strength (green shear strength) | 3.83 | 4.54 | 4.26 | 3.98 | 3.96 |
| [N/cm²] | | | | | |
| Splitting resistance (green splitting | 3.28 | 3.42 | 3.45 | 3.25 | 3.24 |
| resistance) [N/cm²] | | | | | |
| Wet tensile strength [N/cm²] | 0.46 | 0.61 | 0.54 | 0.52 | 0.50 |
| Gas permeability index | 146 | 216 | 208 | 196 | 180 |
| Water content [wt %] | 3.15 | 2.80 | 2.74 | 2.90 | 2.92 |
| DCS 150° C./3 h [N/cm²] | 32.3 | 37.9 | 39.8 | 33.6 | 35.9 |
| DCS 350° C./1.5 h [N/cm²] | 15.3 | 44.4 | 29.5 | 24.2 | 19.3 |
| DCS 550° C./45 min [N/cm²] | 19.5 | 32.1 | 27.1 | 22.1 | 21.3 |
| DCS 750° C./30 min [N/cm²] | 8.3 | 20.7 | 9.8 | 11.2 | 9.9 |

### 1.4 Emissions of the Bentonite Used and of the Additives Used

Table 10 shows emission measurements of the bentonite used and of the additives used. The emission measurements were carried out at the Foundry Institute of the University of Freiberg; for this purpose, the materials were introduced in a tubular furnace at 900° C. and the resulting emissions were measured by online FT-IR; calibration was effected using test gases.

The emissions of the additives to be used in accordance with the invention are significantly lower than the emissions of conventional glassy carbon formers such as the above-described ground coke from LuxCarbon or the Carboluxon 100/P product. Although carbonates (not in accordance with the invention) such as manganese carbonate reduce the emissions of hydrocarbons, in particular benzene, toluene, xylene, they lead as expected to distinctly increased CO₂ emission compared to the hydroxides such as Al(OH)₃. According to the invention, carbonates are therefore preferably used in combination with hydroxides.

TABLE 10
Results of emission measurements with use of different additives
(all Figures in mg/kg, i.e. mg of the emission in question/kg of material)

| | | | | | | | | | | | Ethylben- |
|---|---|---|---|---|---|---|---|---|---|---|---|
| | CO | CO₂ | CH₄ | C₂H₄ | PhOH | CH₂O | Naphthalene | Benzene | Toluene | Xylenes | zene |
| Sodium bentonite | 50 | 3242 | 6 | 0 | 0 | 1 | 0 | 3 | 1 | 0 | 0 |
| Hard coal | 3710 | 8549 | 1215 | 5132 | 71 | 62 | 63 | 278 | 6 | 1 | 3 |
| Carboluxon 100/P | 4208 | 12752 | 1515 | 5966 | 91 | 78 | 73 | 307 | 10 | 1 | 2 |
| Al(OH)₃ | 35 | 2957 | 4 | 0 | 0 | 1 | 0 | 5 | 1 | 0 | 0 |
| MnCO₃ | 16 | 17654 | 4 | 0 | 0 | 1 | 0 | 5 | 1 | 0 | 0 |

### 2. Production and Testing of Molding Materials in the Cycle

These tests have the aim of repeatedly using a particular amount of molding material for casting, and reprocessing. As is customary in industrial foundry practice, the molding material is in a cycle. Additives are supplied every time the molding material is processed and accumulate with each loop. Components that are present in the starting molding material but are no longer added are depleted, meaning that the proportions of components that are no longer added in the subsequent loops are reduced. The total amount of the molding material in the cycle is constant and is around 8 kg. Two molds per loop are produced and used for casting according to the sleeve model setup as described in (https://www.researchdisclosure.com/database/RD705032).

For illustration of experimental procedure, reference is made to the molding material cycle in FIG. 2.

The loops of the molding material cycle comprise the following steps:

Producing the molding material (step (1), first loop)
Experiment series 2.1, 2.2.1, 2.2.2, 2.3.1, 2.3.2 as described below

In the first loop, 6 kg of quartz sand of the H32 type from Quarzwerke is used. The mold base material is then mixed with 480 g of sodium bentonite (Natroben 25F, HA ITALIA S.p.A., which is an Na bentonite produced by activating a natural Ca bentonite) and 300 g of the respective additive and 120 ml of water in a pan mill mixer from Morek Multiserw without water for 1 minute, and then mixed again after adding water for 7 minutes. For this purpose, first of all, the mold base material is mixed with 120 ml of water in a pan mill mixer from Morek Multiserw for 1 minute, and then mixed, after adding 480 g of sodium bentonite (Natroben 25F, HA ITALIA S.p.A.) and 300 g of the respective additive, in a pan mill mixer from Morek Multiserw for another 7 minutes.

Experiment series 2.4-2.6 as described below

In the first loop, 3.7 kg of quartz sand of the H32 type from Quarzwerke is used. The mold base material is then mixed with 322 g Volclay (GEKO™ V foundry bentonite from Clariant Deutschland GmbH, which is a naturally occurring Na bentonite) and 207 g of the respective additive and 130 ml of water in a pan mill mixer from Morek Multiserw without water for 1 minute, and then mixed again after adding water for 7 minutes. For this purpose, first of all, the mold base material is mixed with 130 ml of water in a pan mill mixer from Morek Multiserw for 1 minute, and then mixed, after adding 322 g of Volclay and 207 g of the respective additive, in a pan mill mixer from Morek Multiserw for another 7 minutes.

The further details are applicable to all experiment series 2.1 to 2.6 (unless stated otherwise).

Every time the molding material is produced (step (1)), additives are added and accumulate with each loop. The discharge of a portion of the molding material used for casting in step (5) or in step (1) of the next loop (cf. FIG. 2) reduces the proportion of components that are present in the starting molding material but no longer added.

Producing the mold (step (2) in all loops)

For this purpose, the molding material, 3 minutes after being mixed, is introduced into the mold of the sleeve model device and compressed in 2 pressing operations (filling, pressing, refilling, pressing). The process is complete within a further 3 minutes. 2 molds are produced in each experiment.

### Casting (Step (3) in all Loops)

After a wait time of 30 minutes, the molds are used for casting one after another. The mold is used to cast liquid metal of the GJL 250 alloy at 1450° C. with the aid of a ladle. The mold that has been used for casting is left to stand overnight before division. At the same time, the casting cools down, and the molding material first heats up and cools down overnight in the mold.

### Dividing (Step (4) in all Loops)

Casting and molding material used for casting are divided.

### Processing (Step (5) in all Loops)

The molding material is introduced into a storage vessel and the molding material lumps are crushed. Metal residues are removed.

### Producing the Molding Material (Step (1) in the 2nd Loop and Every Further Loop)

A new molding material is produced by refreshing the processed molding material from the previous loop (first processed molding material) by admixture of bentonite, water, additive (as defined above) and fresh mold base material (new sand) or a second processed molding material by processing cores (see below for details).

Fresh mold base material or a second processed molding material produced by processing cores (see below for details) is added to the processed molding material from the previous loop and mixed with 120 ml of water for 1 minute, and addition of sodium bentonite (Natroben 25F, HA ITALIA S.p.A., experiment series 2.1, 2.2.1, 2.2.2, 2.3.1, 2.3.2) or Volclay (GEKO™ V foundry bentonite from Clariant Deutschland GmbH, experiment series 2.4, 2.5 and 2.6) and of the respective additive (see below for amounts of bentonite and additive) is then followed by mixing in a pan mill mixer from Morek Multiserw for another 7 minutes.

The increase in the amount of the molding material resulting from additions in the mixer, i.e. the increase in the amount of the molding material resulting from the above-defined admixture, is controlled by with-drawing the same amount of ready-mixed molding material in each loop.

Every time the molding material is produced (step (1)), additives are added and accumulate with each loop. The discharge of a portion of the molding material used for casting reduces the proportion of components that are present in the starting molding material but no longer added in the subsequent loops.

2.1 Additive Al(OH)₃ or Mq(OH)₂ on admixture of fresh mold base material in the subsequent loops (not in accordance with the invention)

10 loops (0-9) are performed in each case using the sleeve model setup described in (https://www.re-searchdisclosure.com/database/RD705032); in the first experiment, 100% fresh mold base material of H32 type from Quarzwerke is employed.

In all subsequent loops 1 to 9, 4 kg of the used molding material from the previous casting is used, and refreshed with 400 g of mold base material (fresh mold base material), and also 64 g of bentonite and 20 g of the respective additive.

The aluminum hydroxide Al(OH)₃ additive used is SH950 Nuance-00 from Alteo. The results of the experiments with Al(OH)₃ are shown in table 11.

The magnesium hydroxide Mg(OH)₂ additive used is type 3 brucite from Ziegler & Co. GmbH. The results of the experiments with Mg(OH)₂ are shown in table 12.

Both additives, when fresh mold base material is used as aggregate (cf. FIG. 2, step (1)), show good mold properties and a comparable surface quality, which can be seen from the measured roughness of the castings.

Al(OH)₃ as additive results in a higher active clay content and a distinctly lower ignition loss. For both Al(OH)₃ and Mg(OH)₂, the molding material properties and the castings are of good quality. The surface roughness of the castings is correspondingly low.

TABLE 11
Indices of samples taken in the respective loops for determination of the molding
material properties with Al(OH)₃ as additive, and surface roughness of the casting

| | Processed | | | | | | | Surface |
|---|---|---|---|---|---|---|---|---|
| | starting | Active | | | Green | | | roughness |
| | molding | clay | Water | | compressive | Ignition | Gas | of the |
| | material | content | content | Compactability | strength | loss | permeability | casting |
| Loop | [wt %] | % | [wt %] | [%] | [N/cm²] | [%] | index | [μm] |
| 0 | 100% | 6.4% | 2.5% | 43% | 15.8 | 2.12 | 179 | 150 |
| 1 | 78% | 6.5% | 2.5% | 43% | 19.8 | 2.06 | 174 | 148 |
| 2 | 69% | 7.3% | 2.7% | 44% | 20.6 | 1.98 | 188 | 144 |
| 3 | 61% | 8.0% | 2.8% | 41% | 21.4 | 1.91 | 189 | 151 |
| 4 | 53% | 7.4% | 2.9% | 43% | 23.1 | 1.85 | 198 | 168 |
| 5 | 47% | 6.9% | 2.9% | 40% | 23.2 | 1.86 | 195 | 163 |
| 6 | 42% | 7.4% | 3.1% | 43% | 23.5 | 1.86 | 200 | 152 |
| 7 | 37% | 8.0% | 3.3% | 45% | 22.3 | 1.74 | 216 | 173 |
| 8 | 32% | 7.7% | 3.3% | 43% | 22.1 | 1.85 | 224 | 175 |
| 9 | 29% | 8.6% | 3.4% | 45% | 21.2 | 1.81 | 236 | 174 |
| | Mean | 7.4% | 2.9% | 43% | 21.3 | 1.90 | 200 | 160 |
| | Standard | 0.7% | 0.3% | 1.4% | 2.2 | 0.11 | 19 | 11 |
| | deviation | | | | | | | |

TABLE 12
Indices of samples taken in the respective loops for determination of the molding
material properties with Mg(OH)₂ as additive, and surface roughness of the casting

| | Processed | | | | | | | Surface |
|---|---|---|---|---|---|---|---|---|
| | starting | Active | | | Green | | | roughness |
| | molding | clay | Water | | compressive | Ignition | | of the |
| | material | content | content | Compactability | strength | loss | Gas | casting |
| Loop | [wt %] | [%] | [wt %] | [%] | [N/cm²]] | [%] | permeability | [μm] |
| 0 | 100% | 5.7% | 2.6% | 42% | 18.9 | 2.08 | 177 | 158 |
| 1 | 78% | 4.9% | 3.0% | 43% | 22.3 | 2.11 | 204 | 154 |
| 2 | 69% | 5.1% | 3.1% | 43% | 22.5 | 2.16 | 218 | 149 |
| 3 | 61% | 5.5% | 3.2% | 42% | 22.0 | 2.21 | 223 | 167 |
| 4 | 53% | 6.2% | 3.2% | 43% | 22.9 | 2.24 | 220 | 180 |
| 5 | 47% | 5.9% | 3.2% | 40% | 22.8 | 2.26 | 205 | 157 |
| 6 | 42% | 6.5% | 3.4% | 42% | 22.5 | 2.25 | 210 | 169 |
| 7 | 37% | 6.2% | 3.6% | 42% | 21.0 | 2.25 | 186 | 157 |
| 8 | 32% | 7.4% | 3.4% | 42% | 22.7 | 2.21 | 199 | 167 |
| 6 | 29% | 7.0% | 3.5% | 42% | 23.0 | 2.22 | 206 | 183 |
| | Mean | 6.0% | 3.2% | 42% | 22.1 | 2.20 | 205 | 164 |
| | Standard | 0.8% | 0.3% | 0.9% | 1.2 | 0.06 | 14 | 10 |
| | deviation | | | | | | | |

2.2 Al(OH)₃ and Mg(OH)₂ on Admixture of Coldbox Core Sand in the Subseqiuent Loops (not in Accordance with the Invention)

31 loops (0-30) are performed in each case using the sleeve model setup described in (https://www.re-searchdisclosure.com/database/RD705032). The experimental procedure and measurement of the molding material and casting properties is as described in chapter 2.1, except for addition, in the subsequent loops, not of fresh mold base material but of a second processed molding material (see FIG. 2, step (1)) produced by processing cores that have not been used for casting (for the proportion in the molding material produced see table 13 or 16) and have been produced with coldbox binder (“coldbox core sand”).

2.2.1 Aluminum Hydroxide Al(OH)₃ with Admixture of Coldbox Core Sand in the Subseqiuent Loops

When aluminum hydroxide Al(OH)₃ is used, the molding material properties are sufficiently stable with 5% admixture of coldbox core sand that the admixture is increased to 10% coldbox core sand from loop 15 onward (tables 13 and 14). The molding material properties still remained stable.

TABLE 13
Composition and compactability of the molding material mixture in the individual loops

| | | | Core | | | | | |
|---|---|---|---|---|---|---|---|---|
| | Molding | | sand | | | | | |
| | material | | in | | | | | |
| | from | Core | the | | | | | |
| | prior | sand | molding | Bentonite | Additive | Water | Water | |
| | loop | dosage | material | dosage | dosage | dosage | content | Compactability |
| Loop | [g] | in g | [%] | in g | in g | in ml | [%] | [%] |
| 0 | 6000 | 300 | 4.8 | 480 | 300 | 120 | 2.55 | 42.0 |
| 1 | 3800 | 190 | 9.3 | 26.6 | 22.8 | 50 | 2.79 | 45.0 |
| 2 | 3750 | 188 | 13.6 | 26.3 | 22.5 | 50 | 2.84 | 45.0 |
| 3 | 3800 | 190 | 17.7 | 26.6 | 22.8 | 50 | 3.01 | 45.9 |
| 4 | 3800 | 190 | 21.7 | 26.6 | 22.8 | 50 | 3.05 | 45.1 |
| 5 | 3800 | 190 | 25.4 | 26.6 | 22.8 | 50 | 3.01 | 41.5 |
| 6 | 3800 | 190 | 28.9 | 26.6 | 22.8 | 50 | 2.98 | 38.9 |
| 7 | 3800 | 190 | 32.3 | 26.6 | 22.8 | 50 | 2.97 | 38.1 |
| 8 | 3750 | 188 | 35.5 | 26.3 | 22.5 | 50 | 3.26 | 44.1 |
| 6 | 3750 | 188 | 38.6 | 26.3 | 22.5 | 50 | 3.47 | 47.0 |
| 10 | 3750 | 188 | 41.5 | 26.3 | 22.5 | 50 | 3.49 | 44.5 |
| 11 | 3700 | 185 | 44.3 | 25.9 | 22.2 | 50 | 3.54 | 45.2 |
| 12 | 3700 | 185 | 47.0 | 25.9 | 22.2 | 50 | 3.65 | 43.9 |
| 13 | 3750 | 188 | 49.5 | 26.3 | 22.5 | 50 | 3.72 | 46.2 |
| 14 | 3800 | 190 | 51.9 | 26.6 | 22.8 | 50 | 3.82 | 44.0 |
| 15 | 3800 | 380 | 56.3 | 41.8 | 32.3 | 50 | 3.69 | 44.0 |
| 16 | 3800 | 380 | 60.3 | 41.8 | 32.3 | 50 | 3.52 | 41.2 |
| 17 | 3800 | 380 | 63.9 | 41.8 | 32.3 | 50 | 3.63 | 42.0 |
| 18 | 3800 | 380 | 67.2 | 41.8 | 32.3 | 50 | 3.48 | 40.0 |
| 19 | 3800 | 380 | 70.1 | 41.8 | 32.3 | 50 | 3.56 | 41.0 |
| 20 | 3800 | 380 | 72.9 | 41.8 | 32.3 | 50 | 3.51 | 42.5 |
| 21 | 3800 | 380 | 75.3 | 41.8 | 32.3 | 50 | 3.57 | 42.7 |
| 22 | 3800 | 380 | 77.6 | 41.8 | 32.3 | 50 | 3.72 | 44.5 |
| 23 | 3800 | 380 | 79.6 | 41.8 | 32.3 | 50 | 3.70 | 42.0 |
| 24 | 3800 | 380 | 81.5 | 41.8 | 32.3 | 50 | 3.74 | 45.0 |
| 25 | 3800 | 380 | 83.1 | 41.8 | 32.3 | 50 | 3.76 | 44.5 |
| 26 | 3800 | 380 | 84.7 | 41.8 | 32.3 | 50 | 3.56 | 43.0 |
| 27 | 3800 | 380 | 86.1 | 41.8 | 32.3 | 50 | 3.58 | 41.5 |
| 28 | 3800 | 380 | 87.3 | 41.8 | 32.3 | 50 | 3.62 | 42.0 |
| 29 | 3800 | 380 | 88.5 | 41.8 | 32.3 | 50 | 3.67 | 46.0 |
| 30 | 3800 | 380 | 89.5 | 41.8 | 32.3 | 50 | 3.68 | 46.0 |
| Mean | | | | | | | 3.4 | 43.4 |

TABLE 14
Indices of samples taken in the respective loops

| | Processed | | | | | |
|---|---|---|---|---|---|---|
| | starting | Active | Green | | | |
| | molding | clay | compressive | | Gas | |
| | material | content | strength | 100*WTS | permeability | Flowability |
| Loop | [wt %] | % | [N/cm²] | [N/cm²] | index | % |
| 0 | 100% | 5.7 | 16.0 | 41.0 | 149 | 50.5 |
| 1 | 93% | | 18.0 | 49.5 | 168 | 52.0 |
| 2 | 86% | | 18.8 | 49.2 | 169 | 51.3 |
| 3 | 80% | | 18.1 | 48.1 | 166 | 51.3 |
| 4 | 75% | | 19.0 | 47.8 | 170 | 51.0 |
| 5 | 69% | | 17.3 | 37.6 | 164 | 49.5 |
| 6 | 64% | | 19.8 | 38.8 | 152 | 49.5 |
| 7 | 60% | | 18.8 | 38.4 | 156 | 49.5 |
| 8 | 56% | | 18.9 | 35.7 | 166 | 50.5 |
| 9 | 52% | | 18.8 | 37.8 | 166 | 51.9 |
| 10 | 48% | | 18.4 | 38.5 | 170 | 51.6 |
| 11 | 45% | | 18.9 | 33.2 | 173 | 52.0 |
| 12 | 41% | | 17.6 | 35.8 | 185 | 51.5 |
| 13 | 38% | 5.9 | 17.6 | 35.5 | 174 | 52.0 |
| 14 | 36% | | 17.6 | 35.2 | 182 | 52.2 |
| 15 | 32% | | 18.4 | 32.0 | 163 | 51.9 |
| 16 | 28% | | 19.7 | 31.3 | 155 | 51.2 |
| 17 | 25% | 6.1 | 18.8 | 36.1 | 149 | 52.0 |
| 18 | 22% | | 18.5 | 32.9 | 150 | 52.0 |
| 19 | 19% | | 17.8 | 32.4 | 149 | 52.1 |
| 20 | 17% | 5.8 | 19.8 | 30.1 | 154 | 51.5 |
| 21 | 15% | | 17.9 | 29.8 | 161 | 51.5 |
| 22 | 13% | | 16.8 | 34.9 | 155 | 52.6 |
| 23 | 12% | | 17.8 | 33.0 | 165 | 52.2 |
| 24 | 10% | | 16.6 | 32.9 | 155 | \|52.9 |
| 25 | 9% | | 17.9 | 36.2 | 154 | 51.7 |
| 26 | 8% | | 17.8 | 31.7 | 156 | 52.1 |
| 27 | 7% | | 19.3 | 33.1 | 158 | 52.1 |
| 28 | 6% | 6.2 | 18.9 | 35.4 | 170 | 51.0 |
| 29 | 6% | | 17.3 | 39.6 | 163 | 52.0 |
| 30 | 5% | 6.2 | 18.5 | 34.5 | 166 | 51.5 |
| Mean | | 6.0% | 18.2 | 36.7 | 162 | 51.5% |

The data from the CNS analysis of the molding materials from the different loops show the increase in the carbon and nitrogen contents originating from the admixture of coldbox core sand. The surface roughness of the castings is improved in comparison to the experiment series with admixture of new sand (see above 2.1) rather than coldbox core sand; this is attributable to the input of the core sand (table 15).

TABLE 15
CNS analysis of selected loops and surface
roughness of the associated castings

| | | | | | | Standard |
|---|---|---|---|---|---|---|
| | | | | | | deviation |
| | | | | | | of the |
| | Processed | | | | Surface | surface |
| | starting | | | | roughness | roughness |
| | molding | | | | of the | of the |
| | material | C | N | S | casting | casting |
| Loop | [wt %] | [wt %] | [wt %] | [wt %](1) | [μm] | [μm] |
| 1 | 93% | 0.25 | 0.01 | <NG | 153 | 9 |
| 4 | 75% | 0.38 | 0.02 | <NG | 154 | 14 |
| 8 | 56% | 0.49 | 0.03 | <NG | 116 | 8 |
| 12 | 41% | 0.58 | 0.04 | <NG | 151 | 13 |
| 14 | 36% | 0.6 | 0.04 | <NG | | |
| 16 | 28% | 0.69 | 0.05 | <NG | 138 | 7 |
| 18 | 22% | 0.73 | 0.05 | <NG | | |
| 20 | 17% | | | | 124 | 15 |
| 22 | 13% | 0.78 | 0.06 | <NG | | |
| 24 | 10% | | | | 106 | 9 |
| 26 | 8% | 0.85 | 0.06 | <NG | | |
| 30 | 5% | 0.9 | 0.06 | <NG | 114 | 12 |

(1)The abbreviation NG indicates that the measured values are below the detection limit

2.2.2 Mg(OH)₂ with Admixture of Coldbox Core Sand in the Subsequent Loops

With magnesium hydroxide Mg(OH)₂ in the form of type 3 brucite as additive, it is apparent even after a few loops that the properties of the molding material cannot be kept stable. Therefore, in loops 8 and 14, the bentonite content of the molding material is raised (table 16). Nevertheless, there is no stabilization of the molding material indices (table 17). Wet tensile strength in particular decreases as the number of loops increases, and this trend can only be counteracted in the short term by adding further fresh bentonite.

TABLE 16
Composition and compactability of the molding material mixture in the individual loops

| | Molding | | | | | | | |
|---|---|---|---|---|---|---|---|---|
| | material | | | | | | | |
| | from | | Core | | | | | |
| | prior | Core | sand | | | | Water | |
| | loop | sand | content | Bentonite | Additive | Water | content | Compactability |
| Loop | [g] | [g] | [wt %] | [g] | [g] | [ml] | [wt %] | [%] |
| 0 | 6000 | 300 | 4.8 | 480 | 300 | 120 | 2.6 | 42.9 |
| 1 | 3800 | 190 | 9.3 | 19.0 | 13.3 | 50 | 2.5 | 42.5 |
| 2 | 3750 | 188 | 13.6 | 18.8 | 13.1 | 50 | 2.6 | 39.9 |
| 3 | 3800 | 190 | 17.7 | 19.0 | 13.3 | 50 | 2.8 | 42.2 |
| 4 | 3800 | 190 | 21.7 | 19.0 | 13.3 | 50 | 2.9 | 40.0 |
| 5 | 3800 | 190 | 25.4 | 19.0 | 13.3 | 50 | 2.9 | 39.5 |
| 6 | 3800 | 190 | 28.9 | 19.0 | 13.3 | 50 | 3.0 | 40.0 |
| 7 | 3800 | 190 | 32.3 | 19.0 | 13.3 | 50 | 3.2 | 44.0 |
| 8 | 3750 | 188 | 35.5 | 76.09 | 13.3 | 70 | 3.4 | 42.1 |
| 9 | 3750 | 188 | 38.6 | 26.3 | 13.1 | 60 | 3.5 | 41.5 |
| 10 | 3750 | 188 | 41.5 | 26.3 | 13.1 | 70 | 3.4 | 42.9 |
| 11 | 3700 | 185 | 44.3 | 26.3 | 13.1 | 70 | 3.5 | 41.3 |
| 12 | 3700 | 185 | 47.0 | 26.3 | 13.1 | 70 | 3.7 | 44.0 |
| 13 | 3750 | 188 | 49.5 | 26.3 | 13.1 | 70 | 3.7 | 40.5 |
| 14 | 3800 | 190 | 51.9 | 34.04 | 13.3 | 100 | 4.3 | 42.5 |
| 15 | 3800 | 190 | 54.2 | 34.04 | 13.3 | 90 | 4.2 | 39.5 |
| 16 | 3800 | 190 | 56.4 | 34.04 | 13.3 | 80 | 4.1 | 40.0 |
| 17 | 3800 | 190 | 58.5 | 34.04 | 13.3 | 80 | 4.0 | 39.0 |
| 18 | 3800 | 190 | 60.4 | 34.04 | 13.3 | 80 | 4.4 | 43.5 |
| Mean | | | | | | | 3.4 | 41.5 |

TABLE 17
Indices of samples taken in the respective loops

| | Processed | | | | | |
|---|---|---|---|---|---|---|
| | starting | Active | Green | | | |
| | molding | clay | compressive | | Gas | |
| | material | content | strength | 100*WTS | permeability | Flowability |
| Loop | [wt %] | [%] | [N/cm²] | [N/cm²] | index | [%] |
| 0 | 87.0 | 4.8 | 18.2 | 44.6 | 154 | 50.0 |
| 1 | 82.8 | 5.2 | 20.1 | 34.3 | 154 | 50.0 |
| 2 | 78.9 | 4.1 | 21.4 | 27.0 | 150 | 49.8 |
| 3 | 75.1 | 3.1 | 19.8 | 18.4 | 142 | 50.6 |
| 4 | 71.5 | 3.1 | 20.4 | 14.4 | 139 | 49.6 |
| 5 | 68.1 | 2.0 | 18.1 | 9.6 | 142 | 48.6 |
| 6 | 64.9 | 2.0 | 20.0 | 9.1 | 132 | 49.5 |
| 7 | 61.8 | 1.9 | 16.9 | 6.1 | 132 | 50.2 |
| 8 | 58.9 | 3.6 | 21.9 | 14.1 | 137 | 50.0 |
| 6 | 56.0 | 3.3 | 20.7 | 13.6 | 133 | 51.3 |
| 10 | 53.4 | 3.4 | 21.1 | 9.0 | 136 | 51.2 |
| 11 | 50.8 | 3.2 | 21.7 | 10.2 | 131 | 50.6 |
| 12 | 48.4 | 2.9 | 21.4 | 12.2 | 137 | 51.3 |
| 13 | 46.1 | 3.3 | 22.3 | 9.3 | 124 | 50.9 |
| 14 | 43.9 | 6.2 | 21.8 | 18.3 | 128 | 51.7 |
| 15 | 41.8 | 6.9 | 23.2 | 21.3 | 123 | 50.8 |
| 16 | 39.8 | 6.2 | 23.6 | 22.3 | 125 | 50.5 |
| 17 | 37.9 | 5.4 | 23.5 | 20.8 | 126 | 51.5 |
| 18 | 36.1 | 4.8 | 22.1 | 17.5 | 133 | 52.5 |

As expected, admixture of coldbox core sand increases the carbon content and, to a limited degree, also the nitrogen content of the molding material (table 18). The surface roughness of the castings is good and is not adversely affected. In contrast to aluminum hydroxide Al(OH)₃ (see experiment series 2.2.1 above), however, magnesium hydroxide Mg(OH)₂ with feeding of organic core sand (i.e. coldbox core sand, see above) does not enable a molding material cycle with stable molding material properties (table 17).

TABLE 18
CNS analysis of selected loops and surface
roughness of the associated castings

| | | | | | | Standard |
|---|---|---|---|---|---|---|
| | | | | | | deviation |
| | | | | | | of the |
| | Processed | | | | Surface | surface |
| | starting | | | | roughness | roughness |
| | molding | | | | of the | of the |
| | material | C | N | S | casting | casting |
| Loop | [wt %] | [wt %] | [wt %] | %(1) | [μm] | [μm] |
| 1 | 82.8 | 0.33 | 0.01 | <NG | 144 | 14 |
| 4 | 71.5 | 0.45 | 0.02 | <NG | 149 | 11 |
| 8 | 58.9 | 0.61 | 0.03 | <NG | 128 | 10 |
| 12 | 48.4 | 0.74 | 0.04 | <NG | 140 | 7 |
| 14 | 43.9 | 0.79 | 0.04 | <NG | | |
| 16 | 39.8 | 0.82 | 0.04 | <NG | 132 | 10 |
| 18 | 36.1 | 0.84 | 0.04 | <NG | 148 | 16 |

(1)The abbreviation NG indicates that the measured values are below the detection limit

2.3 Al(OH)₃ and Mg(OH)₂ with Admixture of Inorganically Bound Core Sand in the Subsequent Loops

31 loops (0-30) are performed in each case using the sleeve model setup described in (https://www.re-searchdisclosure.com/database/RD705032). The experimental procedure and measurement of the molding material and casting properties is as described in chapter 2.1, except for addition, in the subsequent loops, not of fresh mold base material but of a second processed molding material (see FIG. 2, step (1)) produced by processing cores that have not been used for casting (for the proportion in the molding material produced see table 19 or 22) and have been produced with inorganic binder (waterglass) (“IOB core sand”). This is therefore an inorganic molding material cycle in relation to all the binders used.

2.3.1 Aluminum Hydroxide Al(OH)₃ as Additive with Admixture of Inorganically Bound Core Sand in the Subsequent Loops

Even in the case of admixture of IOB core sand, use of aluminum hydroxide Al(OH)₃ gives a molding material cycle with stable molding material properties, and so the admixture of IOB core sand starting from loop 15 is increased to 10% (tables 19 and 20).

TABLE 19
Composition and compactability of the molding material mixtures in the individual loops

| | Molding | | | | | | | |
|---|---|---|---|---|---|---|---|---|
| | material | | | | | | | |
| | from | | Core | | | | | |
| | prior | Core | sand | | | | Water | |
| | loop | sand | content | Bentonite | Additive | Water | content | Compactability |
| Loop | [g] | [g] | [wt %] | [g] | [g] | [ml] | [%] | [%] |
| 0 | 6000 | 300 | 4.8 | 480 | 300 | 120 | 2.6 | 44.0 |
| 1 | 3800 | 190 | 9.3 | 26.6 | 22.8 | 50 | 2.7 | 46.0 |
| 2 | 3750 | 188 | 13.6 | 26.3 | 22.5 | 50 | 2.8 | 44.8 |
| 3 | 3800 | 190 | 17.7 | 26.6 | 22.8 | 50 | 2.9 | 46.0 |
| 4 | 3800 | 190 | 21.7 | 26.6 | 22.8 | 50 | 3.0 | 43.9 |
| 5 | 3800 | 190 | 25.4 | 26.6 | 22.8 | 50 | 3.0 | 41.0 |
| 6 | 3800 | 190 | 28.9 | 26.6 | 22.8 | 50 | 3.0 | 40.8 |
| 7 | 3800 | 190 | 32.3 | 26.6 | 22.8 | 50 | 3.2 | 42.1 |
| 8 | 3750 | 188 | 35.5 | 26.3 | 22.5 | 50 | 3.3 | 44.6 |
| 9 | 3750 | 188 | 38.6 | 26.3 | 22.5 | 50 | 3.3 | 43.1 |
| 10 | 3750 | 188 | 41.5 | 26.3 | 22.5 | 50 | 3.4 | 46.5 |
| 11 | 3700 | 185 | 44.3 | 25.9 | 22.2 | 50 | 3.4 | 42.6 |
| 12 | 3700 | 185 | 47.0 | 25.9 | 22.2 | 50 | 3.5 | 43.0 |
| 13 | 3750 | 188 | 49.5 | 26.3 | 22.5 | 50 | 3.5 | 43.1 |
| 14 | 3800 | 190 | 51.9 | 26.6 | 22.8 | 50 | 3.5 | 41.8 |
| 15 | 3800 | 380 | 56.3 | 41.8 | 32.3 | 50 | 3.4 | 39.5 |
| 16 | 3800 | 380 | 60.3 | 41.8 | 32.3 | 50 | 3.5 | 42.0 |
| 17 | 3800 | 380 | 63.9 | 41.8 | 32.3 | 50 | 3.7 | 46.0 |
| 18 | 3800 | 380 | 67.2 | 41.8 | 32.3 | 50 | 3.5 | 46.0 |
| 19 | 3800 | 380 | 70.1 | 41.8 | 32.3 | 50 | 3.5 | 42.5 |
| 20 | 3800 | 380 | 72.9 | 41.8 | 32.3 | 50 | 3.5 | 43.0 |
| 21 | 3800 | 380 | 75.3 | 41.8 | 32.3 | 50 | 3.5 | 42.0 |
| 22 | 3800 | 380 | 77.6 | 41.8 | 32.3 | 50 | 3.7 | 44.2 |
| 23 | 3800 | 380 | 79.6 | 41.8 | 32.3 | 50 | 3.7 | 44.5 |
| 24 | 3800 | 380 | 81.5 | 41.8 | 32.3 | 50 | 3.9 | 46.0 |
| 25 | 3800 | 380 | 83.1 | 41.8 | 32.3 | 50 | 3.7 | 44.0 |
| 26 | 3800 | 380 | 84.7 | 41.8 | 32.3 | 50 | 3.5 | 41.0 |
| 27 | 3800 | 380 | 86.1 | 41.8 | 32.3 | 50 | 3.6 | 42.5 |
| 28 | 3800 | 380 | 87.3 | 41.8 | 32.3 | 50 | 3.7 | 42.5 |
| 29 | 3800 | 380 | 88.5 | 41.8 | 32.3 | 50 | 3.7 | 43.5 |
| 30 | 3800 | 380 | 89.5 | 41.8 | 32.3 | 50 | 3.7 | 43.5 |
| Mean | | | | | | | 3.4 | 43.6 |

TABLE 20
Indices of samples taken in the respective loops

| | Processed | | | | | |
|---|---|---|---|---|---|---|
| | starting | | Green | | | |
| | molding | Active | compressive | | Gas | |
| | material | clay content | strength | 100*WTS | permeability | Flowability |
| Loop | [wt %] | [%] | [N/cm²] | [N/cm²] | index | [%] |
| 0 | 87.0 | 5.7 | 17.5 | 44.5 | 146 | 50.5 |
| 1 | 82.8 | | 18.0 | 49.4 | 160 | 50.8 |
| 2 | 78.9 | | 20.7 | 48.9 | 150 | 50.5 |
| 3 | 75.1 | | 19.2 | 48.7 | 155 | 50.5 |
| 4 | 71.5 | | 21.7 | 48.6 | 155 | 50.7 |
| 5 | 68.1 | | 20.3 | 48.1 | 163 | 49.1 |
| 6 | 64.9 | | 22.5 | 47.7 | 155 | 49.5 |
| 7 | 61.8 | | 19.9 | 46.4 | 164 | 50.0 |
| 8 | 58.9 | | 21.4 | 48.7 | 173 | 50.8 |
| 9 | 56.0 | | 20.7 | 48.7 | 170 | 52.7 |
| 10 | 53.4 | | 21.3 | 45.5 | 172 | 52.3 |
| 11 | 50.8 | | 21.2 | 47.5 | 185 | 51.6 |
| 12 | 48.4 | | 21.7 | 48.0 | 180 | 52.4 |
| 13 | 46.1 | 5.7 | 21.5 | 48.4 | 180 | 52.0 |
| 14 | 43.9 | | 20.8 | 46.3 | 173 | 52.2 |
| 15 | 39.9 | | 22.2 | 36.5 | 142 | 51.0 |
| 16 | 36.3 | | 21.7 | 37.6 | 156 | 51.5 |
| 17 | 33.0 | 5.7 | 20.7 | 38.2 | 153 | 52.5 |
| 18 | 30.0 | | 20.1 | 37.5 | 166 | 52.5 |
| 19 | 27.3 | | 21.4 | 34.4 | 155 | 51.8 |
| 20 | 24.8 | 5.5 | 21.8 | 34.6 | 162 | 52.5 |
| 21 | 22.5 | | 21.6 | 36.5 | 162 | 52.0 |
| 22 | 20.5 | | 20.5 | 37.6 | 160 | 52.5 |
| 23 | 18.6 | | 20.5 | 39.6 | 169 | 52.5 |
| 24 | 16.9 | | 18.7 | 38.1 | 156 | 53.0 |
| 25 | 15.4 | | 21.8 | 36.5 | 151 | 51.5 |
| 26 | 14.0 | 6.1 | 22.7 | 35.7 | 149 | 51.0 |
| 27 | 12.7 | | 22.3 | 34.6 | 147 | 51.9 |
| 28 | 11.6 | 5.9 | 21.7 | 36.5 | 184 | 51.0 |
| 29 | 10.5 | | 21.2 | 40.2 | 177 | 51.5 |
| 30 | 9.6 | 5.8 | 21.2 | 39.4 | 176 | 51.0 |
| Mean | | 5.8% | 20.9 | 42.2 | 162.8 | 51.5 |

The molding material analyses (table 21) show that there is no significant accumulation of carbon, nitrogen or sulfur in the molding material; C-containing (carbon-containing) components from the inorganic binder (for example surfactants) are of minor importance. The low C load (carbon load) is one of the major ad-vantages of this inorganic molding material cycle, since only very low emissions are to be expected (see below). In spite of the relatively low carbon content, the surface roughnesses obtained (table 21) are very close to those of the experiments with admixture of coldbox core sand (experiment series 2.2.1).

TABLE 21
CNS analysis of selected loops and surface roughness of the associated castings

| | | | | | | Standard |
|---|---|---|---|---|---|---|
| | | | | | | deviation |
| | | | | | | of the |
| | Processed | | | | Surface | surface |
| | starting | | | | roughness | roughness |
| | molding | | | | of the | of the |
| | material | C | N | S | casting | casting |
| Loop | [wt %] | [wt %](1) | [wt %](1) | [wt %](1) | [μm] | [μm] |
| 1 | 82.8 | 0.13 | <NG | <NG | 150 | 17 |
| 4 | 71.5 | 0.13 | <NG | <NG | 146 | 9 |
| 8 | 58.9 | 0.12 | <NG | <NG | 116 | 8 |
| 12 | 48.4 | 0.14 | <NG | <NG | 157 | 11 |
| 14 | 43.9 | 0.16 | <NG | <NG | | |
| 16 | 36.3 | 0.14 | <NG | <NG | 144 | 7 |
| 20 | 24.8 | | | | 150 | 11 |
| 22 | 20.5 | 0.14 | <NG | <NG | | |
| 24 | 16.9 | | | | 135 | 13 |
| 26 | 14.0 | 0.13 | <NG | <NG | | |
| 30 | 9.6 | 0.15 | <NG | <NG | 145 | 18 |

(1)The abbreviation NG indicates that the measured values are below the detection limit

2.3.2 Magnesium Hydroxide Mg(OH)₂ with Admixture of Inorganically Bound Core Sand in the Subsequent Loops

With magnesium hydroxide Mg(OH)₂ in the form of type 3 brucite as additive, it is apparent even after a few loops that the properties of the molding material cannot be kept stable. Therefore, in loops 8 and 15, the bentonite content of the molding material is raised (table 22). Nevertheless, there is no stabilization of the molding material indices. Wet tensile strength in particular decreases as the number of loops increases, and this trend can only be counteracted in the short term by adding further fresh bentonite (table 23).

Similarly to the admixture of coldbox core sand (experiment series 2.2.2), Mg(OH)₂ as additive thus also does not result in a molding material cycle with stable molding material properties; the water demand of the mixture increases significantly and the other molding material indices also show instability (table 23). The water demand of a molding material corresponds to the water content of the molding material mixture in the moldable state (target compactability). Active clay content and wet tensile strength show a significant decrease as the number of loops increases. Although this can be compensated for by adding bentonite, there is no molding material cycle with stable molding material properties overall.

TABLE 22
Composition and compactability of the molding material mixture in the individual loops

| | | | Core | | | | | |
|---|---|---|---|---|---|---|---|---|
| | Molding | Core | sand | | | | Water | |
| | material | sand | content | Bentonite | Additive | Water | content | Compactability |
| Loop | [g] | [g] | [wt %] | [g] | [g] | [ml] | [%] | [%] |
| 0 | 4000 | 600 | 4.76 | 480 | 300 | 120 | 2.7 | 46.0 |
| 1 | 3800 | 190 | 9.30 | 19.0 | 13.3 | 50 | 2.7 | 47.0 |
| 2 | 3750 | 188 | 13.62 | 18.8 | 13.1 | 50 | 2.6 | 45.2 |
| 3 | 3800 | 190 | 17.73 | 19.0 | 13.3 | 50 | 3.0 | 44.5 |
| 4 | 3800 | 190 | 21.65 | 19.0 | 13.3 | 50 | 2.9 | 42.0 |
| 5 | 3800 | 190 | 25.38 | 19.0 | 13.3 | 50 | 3.2 | 42.9 |
| 6 | 3800 | 190 | 28.93 | 19.0 | 13.3 | 50 | 3.3 | 46.7 |
| 7 | 3800 | 190 | 32.32 | 19.0 | 13.3 | 50 | 3.4 | 43.5 |
| 8 | 3750 | 188 | 35.54 | 76.09 | 13.3 | 70 | 3.4 | 40.0 |
| 9 | 3750 | 188 | 38.61 | 26.3 | 13.1 | 60 | 3.4 | 40.5 |
| 10 | 3750 | 188 | 41.53 | 26.3 | 13.1 | 70 | 3.7 | 44.0 |
| 11 | 3700 | 185 | 44.32 | 26.3 | 13.1 | 70 | 3.7 | 45.0 |
| 12 | 3700 | 185 | 46.97 | 26.3 | 13.1 | 70 | 3.9 | 45.0 |
| 13 | 3750 | 188 | 49.49 | 26.3 | 13.1 | 70 | 3.7 | 43.0 |
| 14 | 3800 | 190 | 51.90 | 34.04 | 13.3 | 100 | 4.5 | 43.0 |
| 15 | 3800 | 190 | 54.19 | 34.04 | 13.3 | 90 | 4.8 | 44.6 |
| 16 | 3800 | 190 | 56.37 | 34.04 | 13.3 | 80 | 4.5 | 45.0 |
| 17 | 3800 | 190 | 58.45 | 34.04 | 13.3 | 80 | 4.5 | 43.0 |
| 18 | 3800 | 190 | 60.43 | 34.04 | 13.3 | 80 | 4.5 | 45.0 |

TABLE 23
Indices of samples taken in the respective loops

| | Processed | | | | | |
|---|---|---|---|---|---|---|
| | starting | | Green | | | |
| | molding | Active | compressive | | Gas | |
| | material | clay content | strength | 100*WTS | permeability | Flowability |
| Loop | [wt %] | % | [N/cm²] | [N/cm²] | index | [%] |
| 0 | 100% | 4.8 | 18.6 | 42.7 | 159 | 51.5 |
| 1 | 87.0 | 4.2 | 19.4 | 36.8 | 164 | 51.9 |
| 2 | 82.8 | 3.8 | 20.6 | 27.9 | 158 | 51.0 |
| 3 | 78.9 | 3.2 | 19.7 | 16.5 | 157 | 51.0 |
| 4 | 75.1 | 2.6 | 19.8 | 14.8 | 156 | 50.6 |
| 5 | 71.5 | 2.4 | 20.3 | 10.3 | 163 | 49.6 |
| 6 | 68.1 | 2.3 | 19.3 | 10.3 | 150 | 50.3 |
| 7 | 64.9 | 2.0 | 19.5 | 8.5 | 154 | 50.3 |
| 8 | 61.8 | 3.2 | 22.6 | 16.3 | 142 | 50.1 |
| 9 | 58.9 | 3.5 | 19.1 | 14.5 | 149 | 51.6 |
| 10 | 56.1 | 3.2 | 21.4 | 13.6 | 168 | 52.5 |
| 11 | 53.4 | 3.5 | 21.1 | 13.3 | 165 | 51.8 |
| 12 | 50.8 | 3.7 | 21.4 | 12.7 | 168 | 52.4 |
| 13 | 48.4 | 3.3 | 22.6 | 12.4 | 156 | 52.0 |
| 14 | 46.1 | 7.4 | 23.4 | 20.5 | 140 | 51.5 |
| 15 | 43.9 | 7.9 | 23.5 | 26.0 | 172 | 52.3 |
| 16 | 39.9 | 7.4 | 22.6 | 24.8 | 183 | 52.1 |
| 17 | 36.3 | 7.1 | 23.0 | 25.4 | 166 | 51.3 |
| 18 | 33.0 | 6.9 | 22.7 | 24.8 | 154 | 52.5 |

The analysis of selected molding material samples (table 24) shows a slight rise in carbon content for high numbers of loops, which probably originates from the addition of bentonite; Ca bentonites are treated with carbonates in the activation. The surface roughnesses of the castings are always acceptable, i.e. good to very good.

TABLE 24
CNS analysis of selected loops and surface roughness of the associated castings

| | | | | | | Standard |
|---|---|---|---|---|---|---|
| | | | | | | deviation |
| | | | | | | of the |
| | Processed | | | | Surface | surface |
| | starting | | | | roughness | roughness |
| | molding | | | | of the | of the |
| | material | C | N | S | casting | casting |
| Loop | [wt %] | [wt %](1) | [wt %](1) | [wt %](1) | [μm] | [μm] |
| 1 | 87.0 | 0.18 | <NG | <NG | 151 | 16 |
| 4 | 75.1 | 0.23 | <NG | <NG | 141 | 11 |
| 8 | 61.8 | 0.24 | <NG | <NG | 132 | 11 |
| 12 | 50.8 | 0.26 | <NG | <NG | 154 | 7 |
| 14 | 46.1 | 0.30 | <NG | <NG | | |
| 16 | 39.9 | 0.37 | <NG | <NG | 196 | 28 |
| 18 | 33.0 | 0.28 | <NG | <NG | 172 | 6 |

(1)The abbreviation NG indicates that the measured values are below the detection limit

2.4 Additive Al(OH)₃ on Admixture of Fresh Mold Base Material in the Subseqiuent Loops (not in AccordAnce with the Invention)

11 loops (0-10) are performed using the sleeve model setup described in (https://www.researchdisclo-sure.com/database/RD705032); in the first experiment, 100% fresh mold base material of H32 type from Quarzwerke is employed.

In all subsequent loops 1 to 10, 3.7 kg of the used molding material from the previous casting is used, and refreshed with 185 g of mold base material (fresh mold base material), and also 26 g of bentonite and 23 g of the respective additive (table 25). The aluminum hydroxide Al(OH)₃ additive used is SH950 Nuance-00 from Alteo. Stable molding material properties have been achieved (table 26).

When fresh mold base material is used as aggregate (cf. FIG. 2, step (1)), good mold properties and good to very good surface quality are achieved, which can be seen from the measured roughness of the castings. As expected, the CNS analysis after 11 loops does not show significant levels of carbon and nitrogen since only inorganic materials were used (cf. table 27).

TABLE 25
Composition and compactability of the molding material mixture in the individual loops

| | Molding | | New | | | | | |
|---|---|---|---|---|---|---|---|---|
| | material | New | sand | | | | | |
| | from | sand | in the | | | Water | | |
| | prior | dosage | molding | Bentonite | Additive | dosage | Water | |
| | loop | in | material | dosage | dosage in | in | content | Compactability |
| Loop | [g] | g | [%] | in g | g | ml | [%] | [%] |
| 0 | 3700 | 185 | 4.8 | 322 | 207 | 130 | 2.4 | 42.1 |
| 1 | 3700 | 185 | 9.3 | 25.9 | 22.2 | 50 | 2.6 | 41.0 |
| 2 | 3850 | 193 | 13.6 | 27.0 | 23.1 | 50 | 2.6 | 39.5 |
| 3 | 3800 | 190 | 17.7 | 26.6 | 22.8 | 50 | 2.6 | 42.0 |
| 4 | 3800 | 190 | 21.7 | 26.6 | 22.8 | 50 | 2.7 | 41.5 |
| 5 | 3750 | 188 | 25.4 | 26.3 | 22.5 | 50 | 2.9 | 40.5 |
| 6 | 3800 | 190 | 28.9 | 26.6 | 22.8 | 50 | 3.0 | 42.0 |
| 7 | 3750 | 188 | 32.3 | 26.3 | 22.5 | 50 | 3.0 | 44.5 |
| 8 | 3700 | 185 | 35.5 | 25.9 | 22.2 | 50 | 3.1 | 43.0 |
| 9 | 3700 | 185 | 38.6 | 25.9 | 22.2 | 50 | 3.2 | 44.0 |
| 10 | 3700 | 185 | 41.5 | 25.9 | 22.2 | 50 | 3.2 | 44.5 |

| | | |
|---|---|---|
| Mean | 2.9 | 42.2 |

TABLE 26
Indices of samples taken in the respective loops

| | Processed | | | | | |
|---|---|---|---|---|---|---|
| | starting | Active | Green | | | |
| | molding | clay | compressive | | Gas | |
| | material | content | strength | 100*WTS | permeability | Flowability |
| Loop | [wt %] | % | [N/cm²] | [N/cm²] | index | % |
| 0 | 85.5 | 8.9 | 18.1 | 47.8 | 154 | 50.5 |
| 1 | 79.4 | 6.6 | 19.5 | 49.2 | 194 | 51.5 |
| 2 | 73.8 | 7.8 | 17.4 | 40.1 | 165 | 51.5 |
| 3 | 68.6 | 7.9 | 18.8 | 48.9 | 177 | 53.5 |
| 4 | 63.7 | 8.5 | 17.3 | 49.6 | 202 | 53.1 |
| 5 | 59.2 | 8.9 | 18.7 | 48.9 | 175 | 52.2 |
| 6 | 55.0 | 9.0 | 18.4 | 49.4 | 201 | 52.3 |
| 7 | 51.1 | 8.8 | 19.9 | 49.3 | 223 | 52.5 |
| 8 | 47.5 | 8.8 | 21.1 | 52.0 | 216 | 53.2 |
| 9 | 44.1 | 8.9 | 19.0 | 52.9 | 222 | 53.5 |
| 10 | 41.0 | 8.9 | 20.1 | 50.9 | 231 | 53.2 |
| Mean | | 8.4 | 18.9 | 49.0 | 196 | 52.5 |

TABLE 27
CNS analysis of selected loops and surface roughness of the associated castings

| | | | | | | | Standard |
|---|---|---|---|---|---|---|---|
| | | | | | | | deviation |
| | | | | | | | of the |
| | Processed | | | | | Surface | surface |
| | starting | | | | | roughness | roughness |
| | molding | | | | | of the | of the |
| | material | Ignition | C | N | S | casting | casting |
| Loop | [wt %] | loss [wt %] | [wt %] | [wt %] | [wt %](1) | [μm] | [μm] |
| 0 | 85.5 | | | | | 140 | 10 |
| 1 | 79.4 | | | | | 140 | 15 |
| 2 | 73.8 | | | | | 138 | 10 |
| 3 | 68.6 | | | | | 138 | 10 |
| 4 | 63.7 | | | | | 144 | 10 |
| 5 | 59.2 | | | | | 144 | 10 |
| 6 | 55.0 | | | | | 139 | 15 |
| 7 | 51.1 | | | | | 162 | 10 |
| 8 | 47.5 | | | | | 163 | 16 |
| 9 | 44.1 | | | | | 145 | 16 |
| 10 | 41.0 | 2.4 | 0.07 | <NG | 0.02 | 159 | 14 |
| Mean | | | | | | 147 | 12 |

(1)The abbreviation NG indicates that the measured values are below the detection limit

2.5 Al(OH)₃ with the Addition of Coldbox Core Sand in the Subsequent Loops (not in Accordance with the Invention)

11 loops (0-10) are performed using the sleeve model setup described in (https://www.researchdisclo-sure.com/database/RD705032). The experimental procedure and measurement of the molding material and casting properties is as described in chapter 2.4, except for addition, in the subsequent loops, not of fresh mold base material but of a second processed molding material (see FIG. 2, step (1)) produced by processing cores that have not been used for casting (for the proportion in the molding material produced see table 28) and have been produced with coldbox binder (“coldbox core sand”). Stable molding material properties have been achieved (table 29).

TABLE 28
Composition and compactability of the molding material mixture in the individual loops

| | Molding | | Core | | | | | |
|---|---|---|---|---|---|---|---|---|
| | material | Core | sand | | | | | |
| | from | sand | in the | | Additive | Water | | |
| | prior | dosage | molding | Bentonite | dosage | dosage | Water | |
| | loop | in | material | dosage in | in | in | content | Compactability |
| Loop | [g] | g | [%] | g | g | ml | [%] | [%] |
| 0 | 3700 | 185 | 4.8 | 322 | 207 | 130 | 2.6 | 43.0 |
| 1 | 3800 | 190 | 9.3 | 26.6 | 22.8 | 50 | 2.7 | 41.5 |
| 2 | 3800 | 190 | 13.6 | 26.6 | 22.8 | 50 | 2.7 | 40.0 |
| 3 | 3850 | 193 | 17.7 | 27.0 | 23.1 | 50 | 2.9 | 44.5 |
| 4 | 3800 | 190 | 21.7 | 26.6 | 22.8 | 50 | 3.0 | 42.5 |
| 5 | 3750 | 188 | 25.4 | 26.3 | 22.5 | 50 | 3.0 | 39.7 |
| 6 | 3750 | 188 | 28.9 | 26.3 | 22.5 | 50 | 3.1 | 40.5 |
| 7 | 3750 | 188 | 32.3 | 26.3 | 22.5 | 50 | 3.1 | 40.5 |
| 8 | 3750 | 188 | 35.5 | 26.3 | 22.5 | 50 | 3.4 | 45.0 |
| 9 | 3750 | 188 | 38.6 | 26.3 | 22.5 | 50 | 3.5 | 45.0 |
| 10 | 3700 | 185 | 41.5 | 25.9 | 22.2 | 50 | 3.3 | 40.0 |

| | | |
|---|---|---|
| Mean | 3.0 | 42.0 |

TABLE 29
Indices of samples taken in the respective loops

| | Processed | | | | | |
|---|---|---|---|---|---|---|
| | starting | Active | | | | |
| | molding | clay | | | Gas | |
| | material | content | GCS | 100*WTS | permeability | Flowability |
| Loop | [wt %] | % | [N/cm²] | [N/cm²] | index | % |
| 0 | 85.5 | 10.0 | 16.1 | 40.6 | 163 | 51.9 |
| 1 | 79.4 | 7.0 | 18.0 | 48.2 | 172 | 51.0 |
| 2 | 73.8 | 7.7 | 16.4 | 42.7 | 146 | 51.5 |
| 3 | 68.6 | 8.8 | 18.6 | 49.3 | 162 | 52.3 |
| 4 | 63.7 | 8.4 | 19.1 | 48.1 | 167 | 52.1 |
| 5 | 59.2 | 9.0 | 19.8 | 45.9 | 164 | 52.0 |
| 6 | 55.0 | 8.7 | 19.8 | 42.3 | 170 | 52.0 |
| 7 | 51.1 | 8.8 | 19.6 | 40.2 | 189 | 51.6 |
| 8 | 47.5 | 8.7 | 18.1 | 39.8 | 189 | 52.5 |
| 9 | 44.1 | 9.0 | 17.7 | 44.3 | 195 | 52.9 |
| 10 | 41.0 | 8.6 | 19.8 | 35.9 | 181 | 51.1 |
| Mean | | 8.6 | 18.4 | 43.3 | 173 | 51.9 |

The data from the CNS analysis of the molding material after 11 loops, especially by comparison to the series of experiments with feeding of new sand, shows significant carbon and nitrogen levels originating from the addition of coldbox core sand (table 30).

TABLE 30
CNS analysis of selected loops and surface roughness of the associated castings

| | | | | | | | Standard deviation |
|---|---|---|---|---|---|---|---|
| | | | | | | Surface | of the surface |
| | Processed starting | Ignition | | | | roughness of | roughness of |
| | molding material | loss | C | N | S | the casting | the casting |
| Loop | [wt %] | [wt %] | [wt %] | [wt %] | [wt %](1) | [μm] | [μm] |
| 0 | 85.5 | | | | | 132 | 5 |
| 1 | 79.4 | | | | | 135 | 14 |
| 2 | 73.8 | | | | | 133 | 10 |
| 3 | 68.6 | | | | | 132 | 9 |
| 4 | 63.7 | | | | | 136 | 13 |
| 5 | 59.2 | | | | | 148 | 12 |
| 6 | 55.0 | | | | | 127 | 13 |
| 7 | 51.1 | | | | | 136 | 11 |
| 8 | 47.5 | | | | | 150 | 11 |
| 9 | 44.1 | | | | | 157 | 11 |
| 10 | 41.0 | 2.9 | 0.47 | 0.03 | 0.02 | 160 | 9 |
| Mean | | | | | | 141 | 11 |

(1)The abbreviation NG indicates that the measured values are below the detection limit

2.6 Al(OH)₃ with Admixture of Inorganically Bound Core Sand in the Subseqiuent Loops

11 loops (0-10) are conducted using the sleeve model device described in (https://www.researchdisclo-sure.com/database/RD705032). The test procedure and measurement of the molding material and casting properties is implemented as described in chapter 2.4, except with addition, in the subsequent loops, rather than fresh mold base material, of a second processed molding material (see FIG. 2, step (1)) produced by processing cores that have not been used for casting (for the proportion of molding material produced see table 31) and have been produced with inorganic binder (waterglass) (“IOB3 core sand”). This is therefore an inorganic molding material cycle in relation to all the binders used. Stable molding material properties have been achieved (table 32).

TABLE 31
Composition and compactability of the molding material mixtures in the individual loops

| | Molding | | Core | | | | | |
|---|---|---|---|---|---|---|---|---|
| | material | Core | sand | | | | Water | |
| | from prior | sand | content | Bentonite | Additive | Water | content | Compactability |
| Loop | loop [g] | [g] | [wt %] | [g] | [g] | [ml] | [%] | [%] |
| 0 | 3700 | 185 | 4.8 | 322 | 207 | 130 | 2.5 | 43.0 |
| 1 | 3850 | 193 | 9.3 | 27.0 | 23.1 | 50 | 2.5 | 42.0 |
| 2 | 3800 | 190 | 13.6 | 26.6 | 22.8 | 50 | 2.6 | 40.0 |
| 3 | 3800 | 190 | 17.7 | 26.6 | 22.8 | 50 | 2.8 | 42.0 |
| 4 | 3800 | 190 | 21.7 | 26.6 | 22.8 | 50 | 2.9 | 41.5 |
| 5 | 3750 | 188 | 25.4 | 26.3 | 22.5 | 50 | 3.0 | 43.2 |
| 6 | 3750 | 188 | 28.9 | 26.3 | 22.5 | 50 | 3.0 | 40.5 |
| 7 | 3750 | 188 | 32.3 | 26.3 | 22.5 | 50 | 3.1 | 43.5 |
| 8 | 3750 | 188 | 35.5 | 26.3 | 22.5 | 50 | 3.3 | 42.5 |
| 9 | 3700 | 185 | 38.6 | 25.9 | 22.2 | 50 | 3.3 | 43.0 |
| 10 | 3700 | 185 | 41.5 | 25.9 | 22.2 | 50 | 3.3 | 45.0 |
| Mean | | | | | | | 2.9 | 42.6 |

TABLE 32
Indices of samples taken in the respective loops

| | Processed | | | | | |
|---|---|---|---|---|---|---|
| | starting | Active | | | Gas | |
| | molding | clay | | | perme- | Flow- |
| | material | content | GCS | 100*WTS | ability | ability |
| Loop | [wt %] | [%] | [N/cm²] | [N/cm²] | index | [%] |
| 0 | 85.5 | 8.6 | 16.5 | 38.1 | 144 | 52.0 |
| 1 | 79.4 | 6.9 | 16.7 | 42.8 | 151 | 51.7 |
| 2 | 73.8 | 6.7 | 19.8 | 48.0 | 152 | 51.0 |
| 3 | 68.6 | 8.8 | 19.5 | 49.1 | 162 | 52.0 |
| 4 | 63.7 | 9.2 | 20.4 | 48.9 | 177 | 52.0 |
| 5 | 59.2 | 8.9 | 19.6 | 43.4 | 172 | 53.3 |
| 6 | 55.0 | 9.1 | 21.2 | 48.8 | 174 | 51.7 |
| 7 | 51.1 | 9.4 | 20.5 | 48.2 | 188 | 52.5 |
| 8 | 47.5 | 8.9 | 20.6 | 44.4 | 196 | 52.5 |
| 9 | 44.1 | 9.0 | 18.1 | 48.8 | 200 | 52.7 |
| 10 | 41.0 | 9.1 | 19.0 | 49.2 | 194 | 52.5 |
| Mean | | 8.6 | 19.3 | 46.3 | 174 | 52.2 |

The molding material analyses (table 33) show that there is no significant accumulation of carbon, nitrogen or sulfur in the molding material; C-containing (carbon-containing) components from the inorganic binder (for example surfactants) are of minor importance. The low C load (carbon load) is one of the major ad-vantages of this inorganic molding material cycle, since only very low emissions are to be expected (see below). In spite of the relatively low carbon content, the surface roughnesses obtained (table 33) are comparable to those of the experiments with admixture of coldbox core sand (experiment series 2.5).

TABLE 33
CNS analysis of selected loops and surface roughness of the associated castings

| | | | | | | | Standard deviation |
|---|---|---|---|---|---|---|---|
| | | | | | | Surface | of the surface |
| | Processed starting | Ignition | | | | roughness of | roughness of |
| | molding material | loss | C | N | S | the casting | the casting |
| Loop | [wt %] | [wt %] | [wt %](1) | [wt %](1) | [wt %](1) | [μm] | [μm] |
| 0 | 85.5 | | | | | 134 | 13 |
| 1 | 79.4 | | | | | 131 | 11 |
| 2 | 73.8 | | | | | 123 | 10 |
| 3 | 68.6 | | | | | 132 | 12 |
| 4 | 63.7 | | | | | 137 | 12 |
| 5 | 59.2 | | | | | 144 | 9 |
| 6 | 55.0 | | | | | 138 | 12 |
| 7 | 51.1 | | | | | 136 | 10 |
| 8 | 47.5 | | | | | 147 | 8 |
| 9 | 44.1 | | | | | 148 | 11 |
| 10 | 41.0 | 2.3 | 0.08 | 0.01 | < NG | 144 | 8 |

| | | |
|---|---|---|
| Mean | 138 | 11 |

(1)The abbreviation NG indicates that the measured values are below the detection limit

3. Molding Material Cycle with Gradual Reduction of the Carbon Content in the Molding Material

The aim of these tests is to repeatedly cast and reprocess a particular amount of processed molding material, in particular with a gradual reduction of the carbon content in the molding material. As is customary in industrial foundry practice, the molding material is in a cycle. Additives are supplied every time the molding material is processed and accumulate with each loop. Components that are present in the starting molding material but are no longer added are depleted, meaning that the proportions of components that are no longer added in the subsequent loops are reduced. The total amount of the molding material is constant and is around 1200 kg. Four molds per loop are produced and used for casting according to the fin model setup as described in (https://www.researchdisclosure.com/database/RD705032).

For illustration of experimental procedure, reference is made to the molding material cycle in FIG. 4.

The loops of the molding material cycle comprise the following steps:

### Producing the Molding Material (Step (1), First Loop)

In the first loop, processed molding material (starting molding material) from the molding material cycle of a brake disk foundry is used (see point 0.2 above).

Using a BigBag unloading station and two conveyor belts, the processed molding material is transferred from a BigBag to a bunker upstream of the Eirich mixer (Eirich Intensive Mixer R09 with capacity: 150 liters, max. 240 kg, batchwise operation under normal atmosphere). The previously weighed additives (aggregates), bentonite, mold base material or core molding material and the additive are fed onto the bunker extraction belt. The additive used is Al(OH)₃ of the SH950 type (SH950 nuance-00, Alteo).

Every time a molding material is produced (step (1), cf. FIG. 4), additives are added and accumulate with each loop. The discharge of a portion of the molding material used for casting in step (5) or in step (1) of the next loop (cf. FIG. 4) reduces the proportion of components that are present in the starting molding material but no longer added.

The molding material is removed from the bunker and transported into the mixer together with the aggregates. The mixing process commences, water is dosed automatically, and the finished molding material is emptied from the mixer into a transport container after the mixing process has ended. The transport container is transported to the molding system.

The mixer program selected, depending on the situation (depending on the water content of the mixture), is either a mixing sequence without an intermediate stop (table 35) or a mixing sequence with an intermediate stop (table 34), and the desired compaction is set to 40%+/−5% by monitoring the water content. The desired compaction is established by monitoring compactability. Compactability changes with the water content of the molding material. The water content of each mixture was ascertained. Since the necessary addition of water for achievement of the target compactability is unknown, the intermediate stop in the mixing sequence makes it easier to determine the required amount of water, and the subsequent mixtures can be produced without an intermediate stop.

TABLE 34
Mixing sequence with intermediate stop

| Program step in the mixing | | Agitator | Vessel | |
|---|---|---|---|---|
| program of the Eirich mixer | | rotation m/s | rotation m/s | Time s |
| 0 | Starting position | +6.00 | 1.00 | |
| 1 | Material addition | +6.00 | 0.80 | |
| 2 | Mixing | +6.00 | 0.80 | 15 |
| 3 | Water addition | +6.00 | 1.00 | |
| 4 | Mixing | +12.00 | 1.30 | 70 |
| 5 | Sampling | | | |
| 6 | Mixing | +12.00 | 1.30 | 10 |
| 7 | Water addition | +12.00 | 1.20 | |
| 12 | Mixing | +12.00 | 1.30 | 45 |
| 13 | Mixture finished | +6.00 | 1.00 | |
| 14 | Empty the mixer | +6.00 | 1.00 | 40 |

TABLE 35
Mixing sequence without intermediate stop

| Program step in the mixing | | Agitator | Vessel | |
|---|---|---|---|---|
| program of the Eirich mixer | | rotation/m/s | rotation/m/s | Time/s |
| 0 | Starting position | +6.00 | 1.00 | |
| 1 | Material addition | +6.00 | 0.80 | |
| 2 | Mixing | +6.00 | 0.80 | 15 |
| 3 | Water addition | +6.00 | 1.00 | |
| 4 | Mixing | +12.00 | 1.30 | 90 |
| 13 | Mixture finished | +6.00 | 1.00 | |
| 14 | Empty the mixer | +6.00 | 1.00 | 40 |

### Producing the Mold (Step (2) in all Loops)

For this purpose, part of the volume of the bottom box of the mold is first filled with a layer of screened molding material from the transport container; a sufficient amount of molding material is screened that the contour of the fin model can no longer be seen (this corresponds to a height of 80 mm in the bottom box and a height of 50 mm in the top box). The remaining volume of the bottom box is then filled with unscreened molding material. The screen has a clear mesh size of 2 mm.

The bottom box (i.e. the molding material in the bottom box) is compacted in the HWS HSP-1D molding system with the specified parameters (table 36, mold box size of 700×500×200/200 mm, model plate size of 650×450×30 mm) by a Seiatsu air flow compression molding process. The time during which an air flow is passed through the molding material in the mold box to fluidize the molding material is referred to as Seiatsu time. The Seiatsu time can be set independently for the top and bottom box. The molding material is then compressed.

TABLE 36
Compaction parameters

| | | |
|---|---|---|
| Lower box compression pressure: | 90 | N/cm² |
| Top box compression pressure: | 80 | N/cm² |
| Bottom box compression time: | 2.000 | s |
| Top box compression time: | 2.000 | s |
| Bottom box SEIATSU time: | 0.50 | s |
| Top box SEIATSU time: | 0.50 | s |

The bottom box is manually removed flat and transported to the assembly station with a crane. The top box is filled, compacted, removed and transported in the same way. A previously produced core (step (1a), cf. FIG. 4) is inserted into the lower box (step (2a), cf. FIG. 4). The mold is assembled, braced and transported to the casting station.

### Casting (Step (3) in all Loops)

The mold is used to cast liquid metal of the GJL 250 alloy at 1450° C. with the aid of a ladle in an iron frame with shears on one side.

The next molds are produced (step (2), (2a)) and used for casting.

The mold that has been used for casting is left for 4 hours before division. In the course of this, the casting cools down and the molding material heats up.

### Dividing (Step (4) in all Loops)

The upper and lower boxes are opened. Casting and molding material used for casting are divided. The core sand is handled differently in the three molding material cycles that have been examined:
1. In experiment series A, in which new sand is used as an added mold base material, a core bound with CO₂-hardened waterglass (see point 0.2 above) is used, which does not break down on division and is discharged completely at this point in the loop.
2. In experimental series B, in which coldbox cores are used, the core in the middle breaks down completely and can no longer be separated from the molding material. The core marks do not break down, nor can they be simply comminuted. Therefore, the core marks are discharged at this point in the loop.
3. In experiment series C, in which inorganically bound cores (binder: Cordis 9477/Anorgit 9476; see point 0.2) were used, these break down only in the edge layer, but can be very easily comminuted manually. Therefore, the IOB core sand is not discharged.

### Processing (Step (5) in all Loops)

The molding material is spread out on the floor and molding material lumps are crushed using a shovel. The metal residues are removed. The molding material lies on the hall floor for at least 3 hours for cooling. After cooling, the molding material is filled back into a BigBag with shovels.

### Producing the Molding Material (Step (1) in the 2nd Loop and Every Further Loop)

A new molding material is produced by refreshing the processed molding material from the previous loop (first processed molding material) by admixture of bentonite, water, additive (as defined above) and fresh mold base material (new sand, experiment series A) or a second processed molding material by processing cores (experiment series B and C; see below for details). For the sequence of the mixing process, see the details for step (1) of the first loop above.

The increase in the amount of the molding material resulting from additions in the mixer, i.e. the increase in the amount of the molding material resulting from the above-defined admixture, is controlled by with-drawing the same amount of ready-mixed molding material in each loop.

Every time the molding material is produced (step (1)), additives are added and accumulate with each loop. The discharge of a portion of the molding material used for casting reduces the proportion of components that are present in the starting molding material but no longer added in the subsequent loops.

3.1 Experiment Series with Admixture of Fresh Mold Base Material (New Sand) in Step (1) (Experiment Series a, not in Accordance with the Invention)

When producing the mold (see step (2) above), waterglass-bound cores are used, which do not breakdown after casting (see point 0.2 above) and are removed as described above in step (4).

In an experiment series with 30 loops (A1-A30, cf. table 37), the processed molding material from the previous loop (first processed molding material) is refreshed in each subsequent loop with mold base material of the Grudzen Laz. 0.20/0.315/0.40 type (coarse quartz sand of the 1K class) from Quarzwerke.

TABLE 37
Composition and compactability of the molding material mixture in the individual loops

| | First | Addition | | | | | |
|---|---|---|---|---|---|---|---|
| | processed | of mold | | | Addition | | |
| | molding | base | Addition of | Addition | of water | | |
| | material | material | bentonite | of additive | [propn. | Water | |
| | [propn. by | [propn. | [propn. | [propn. | by wt.] | content | |
| Loop | wt.] (1) | by wt.] | by wt.] | by wt.] | (2) | (3) | Compactability |
| A-1 | 90.2% | 6.4% | 1.2% | 0.5% | 1.6% | 3.0% | 41.3% |
| A-2 | 90.0% | 6.4% | 1.2% | 0.5% | 1.8% | 3.1% | 40.7% |
| A-3 | 90.1% | 6.4% | 1.2% | 0.5% | 1.7% | 2.9% | 42.3% |
| A-4 | 90.2% | 6.4% | 1.2% | 0.5% | 1.6% | 3.1% | 41.5% |
| A-5 | 90.2% | 6.4% | 1.2% | 0.5% | 1.6% | 3.1% | 41.9% |
| A-6 | 90.4% | 6.5% | 1.2% | 0.5% | 1.3% | 3.1% | 40.3% |
| A-7 | 90.2% | 6.4% | 1.2% | 0.5% | 1.6% | 3.1% | 41.4% |
| A-8 | 90.1% | 6.4% | 1.2% | 0.5% | 1.7% | 3.3% | 41.7% |
| A-9 | 90.1% | 6.4% | 1.2% | 0.5% | 1.7% | 3.3% | 40.9% |
| A-10 | 90.2% | 6.4% | 1.1% | 0.5% | 1.8% | 3.1% | 41.8% |
| A-11 | 90.3% | 6.4% | 1.1% | 0.5% | 1.6% | 3.2% | 39.9% |
| A-12 | 90.3% | 6.5% | 1.1% | 0.5% | 1.6% | 3.4% | 42.3% |
| A-13 | 90.5% | 6.5% | 1.1% | 0.5% | 1.4% | 3.3% | 42.5% |
| A-14 | 90.4% | 6.5% | 1.1% | 0.5% | 1.6% | 3.3% | 42.2% |
| A-15 | 90.5% | 6.5% | 1.1% | 0.5% | 1.4% | 3.3% | 43.3% |
| A-16 | 90.8% | 6.5% | 1.1% | 0.5% | 1.1% | 3.3% | 41.8% |
| A-17 | 90.2% | 6.4% | 1.1% | 0.5% | 1.7% | 3.3% | 41.3% |
| A-18 | 90.3% | 6.4% | 1.1% | 0.5% | 1.7% | 3.3% | 39.4% |
| A-19 | 89.8% | 6.4% | 1.1% | 0.5% | 2.2% | 3.3% | 41.0% |
| A-20 | 90.2% | 6.4% | 1.1% | 0.5% | 1.7% | 3.2% | 42.8% |
| A-21 | 90.8% | 6.5% | 1.1% | 0.5% | 1.1% | 3.4% | 43.6% |
| A-22 | 90.2% | 6.4% | 1.1% | 0.5% | 1.7% | 3.3% | 40.0% |
| A-23 | 90.1% | 6.4% | 1.0% | 0.5% | 1.9% | 3.3% | 39.5% |
| A-24 | 90.0% | 6.4% | 1.0% | 0.5% | 2.0% | 3.4% | 39.5% |
| A-25 | 89.8% | 6.4% | 1.0% | 0.5% | 2.3% | 3.3% | 39.5% |
| A-26 | 89.7% | 6.4% | 1.0% | 0.5% | 2.4% | 3.6% | 38.9% |
| A-27 | 90.1% | 6.4% | 1.0% | 0.5% | 2.0% | 3.4% | 38.7% |
| A-28 | 90.0% | 6.4% | 1.0% | 0.5% | 2.0% | 3.3% | 43.0% |
| A-29 | 89.9% | 6.4% | 1.0% | 0.5% | 2.1% | 3.1% | 37.8% |
| A-30 | 90.1% | 6.4% | 1.0% | 0.5% | 1.9% | 3.4% | 38.1% |
| Mean | 90.2% | 6.4% | 1.1% | 0.5% | 1.7% | 3.2% | 41.0% |

(1) “First processed molding material” refers here to the amount of molding material from the previous loop that has been reused after processing
(2) Added dose of water
(3) Measured water content of the mixture

TABLE 38
Indices of samples taken in the respective loops for
determination of the molding material properties

| | Processed | | | | | |
|---|---|---|---|---|---|---|
| | starting | | | | | |
| | molding | Active | Green | 100*wet | Gas | |
| | material | clay | compressive | tensile | perme- | |
| | [propn. | content | strength | strength | ability | Flow- |
| Loop | by wt.] | [%] | [N/cm²] | [N/cm²] | index | ability |
| A-1 | 90% | 5.5% | 23.0 | 42.2 | 146 | 71% |
| A-2 | 81% | 5.7% | 21.1 | 36.2 | 135 | 69% |
| A-3 | 73% | 5.9% | 22.6 | 35.2 | 134 | 67% |
| A-4 | 66% | 6.2% | 20.9 | 32.5 | 135 | 77% |
| A-5 | 60% | 6.2% | 21.1 | 39.1 | 151 | 73% |
| A-6 | 54% | 6.5% | 21.6 | 43.4 | 134 | 70% |
| A-7 | 49% | 6.6% | 22.3 | 33.0 | 123 | 71% |
| A-8 | 44% | 6.7% | 21.3 | 36.2 | 117 | 63% |
| A-9 | 39% | 6.9% | 22.1 | 38.5 | 115 | 63% |
| A-10 | 36% | 6.8% | 20.1 | 38.1 | 145 | 59% |
| A-11 | 32% | 7.1% | 21.7 | 36.6 | 128 | 63% |
| A-12 | 29% | 6.9% | 21.2 | 37.8 | 124 | 59% |
| A-13 | 26% | 6.2% | 21.2 | 41.5 | 143 | 56% |
| A-14 | 24% | 6.6% | 21.1 | 35.8 | 126 | 63% |
| A-15 | 22% | 6.8% | 21.2 | 36.2 | 131 | 55% |
| A-16 | 20% | 6.8% | 22.2 | 46.7 | 137 | 60% |
| A-17 | 18% | 6.8% | 20.6 | 37.5 | 127 | 51% |
| A-18 | 16% | 7.0% | 21.5 | 33.4 | 115 | 68% |
| A-19 | 14% | 7.0% | 21.1 | 33.1 | 126 | 63% |
| A-20 | 13% | 7.0% | 20.6 | 35.6 | 149 | 57% |
| A-21 | 12% | 6.4% | 21.9 | 38.6 | 154 | 53% |
| A-22 | 11% | 6.4% | 21.4 | 36.1 | 136 | 60% |
| A-23 | 9% | 6.3% | 19.3 | 35.6 | 138 | 57% |
| A-24 | 9% | 6.5% | 21.5 | 36.3 | 119 | 64% |
| A-25 | 9% | 6.5% | 20.5 | 34.1 | 129 | 63% |
| A-26 | 8% | 6.8% | 19.8 | 33.0 | 126 | 52% |
| A-27 | 7% | 6.8% | 21.2 | 34.6 | 123 | 57% |
| A-28 | 6% | 6.5% | 18.7 | 30.9 | 144 | 53% |
| A-29 | 6% | 6.9% | 20.4 | 35.9 | 160 | 54% |
| A-30 | 5% | 6.8% | 22.0 | 33.1 | 130 | 50% |
| Mean | | 6.6% | 21.2 | 36.5 | 133 | 61.4% |

TABLE 39
Analysis of samples from individual loops

| | | | | | | Average | | | |
|---|---|---|---|---|---|---|---|---|---|
| | Ignition | C | N | S | Sludge | grain | | | |
| | loss | content | content | content | content | size | AFS | Degree of | Fines <0.125 |
| Loop | [wt %] | [wt %] | [wt %] | [wt %] | [wt %] | [mm] | number | uniformity | mm [wt %] |
| A-1 | 3.30 | 2.18 | 0.04 | 0.04 | 10.6 | 0.31 | 51 | 60.2 | 2.1 |
| A-5 | 2.80 | 1.36 | 0.02 | 0.02 | 10.3 | 0.31 | 51 | 59.1 | 2.7 |
| A-10 | 2.52 | 1.05 | 0.01 | 0.01 | 10.3 | 0.31 | 51 | 58.7 | 2.8 |
| A-15 | 2.29 | 0.82 | 0.01 | 0.01 | 10.6 | 0.30 | 52 | 59.2 | 3.3 |
| A-20 | | 0.58 | 0 | 0 | 10.5 | 0.31 | 52 | 57.4 | 4.0 |
| A-23 | 2.07 | | | | | | | | |
| A-25 | | 0.45 | 0 | 0 | 11.0 | 0.31 | 52 | 56.9 | 4.4 |
| A-27 | 2.01 | | | | | | | | |
| A-29 | 1.93 | | | | | | | | |
| A-30 | | 0.31 | 0 | 0 | 10.9 | 0.31 | 52 | 58.6 | 3.9 |

As expected, a gradual decrease in the ignition loss of the samples can be observed since, as the number of loops increases, less organic material is present in the molding material. This is also shown by the gradual decrease in the levels of carbon, nitrogen and sulfur (table 39). Here, the molding material properties remain essentially unchanged (table 38).

In spite of the decreasing carbon content, no casting defects are observed and the surface roughness of the castings does not change significantly as a result of the reduction in the carbon content (table 40).

TABLE 40
Surface roughnesses of castings produced in the course of experiment series A

| Loop | A-1 | A-5 | A-10 | A-15 | A-20 | A-23 | A-27 | A-30 | Mean |
|---|---|---|---|---|---|---|---|---|---|
| Proportion of starting | 90% | 60% | 36% | 22% | 13% | 9% | 7% | 5% | |
| molding material [wt %] | | | | | | | | | |
| Surface roughness of the | 249 | 250 | 254 | 277 | 253 | 253 | 278 | 290 | 263 |
| casting [μm] | | | | | | | | | |
| Standard deviation of the | 34 | 29 | 19 | 30 | 29 | 34 | 8 | 26 | 26 |
| surface roughness of the | | | | | | | | | |
| casting [μm] | | | | | | | | | |

3.2 Experiment Series with Admixture of Organically Bound Core Sand (Experiment Series B. Not in Accordance with the Invention)

When producing the mold (see step (2) above), coldbox cores (see point 0.2 above) are inserted, which break down completely in the middle and can no longer be separated from the molding material.

In this experiment series with 30 loops (1B1-1B30, cf. table 41), proceeding from the above-described processed starting molding material from a brake disk foundry, a second processed molding material (cf. FIG. 4) produced by processing cores that had been produced with coldbox binder was added; in other words, in every subsequent loop, the processed molding material from the previous loop (first processed molding material) is refreshed with second processed molding material produced by processing cores that have been produced with coldbox binder.

TABLE 41
Composition and compactability of the molding material mixture in the individual loops

| | First | | | | | | |
|---|---|---|---|---|---|---|---|
| | processed | | | | | | |
| | molding | Addition of | | | Addition | | |
| | material | coldbox | Addition of | Addition | of water | | |
| | [propn. | core sand | bentonite | of additive | [propn. | Water | |
| | by wt.] | [propn. | [propn. | [propn. | by wt.] | content | |
| Loop | (1) | by wt.] | by wt.] | by wt.] | (2) | (3) | Compactability |
| B-1 | 91.8% | 4.4% | 1.1% | 0.5% | 2.2% | 2.8% | 42.2% |
| B-2 | 92.0% | 4.4% | 1.1% | 0.5% | 1.9% | 3.0% | 38.5% |
| B-3 | 91.6% | 4.8% | 1.1% | 0.5% | 1.9% | 3.0% | 40.6% |
| B-4 | 91.6% | 4.8% | 1.1% | 0.5% | 2.0% | 3.1% | 42.1% |
| B-5 | 91.8% | 4.8% | 1.1% | 0.5% | 1.8% | 3.0% | 39.4% |
| B-6 | 91.7% | 4.8% | 1.1% | 0.5% | 1.9% | 2.9% | 40.0% |
| B-7 | 91.5% | 4.8% | 1.1% | 0.5% | 2.1% | 3.1% | 43.0% |
| B-8 | 91.5% | 4.8% | 1.1% | 0.5% | 2.1% | 3.0% | 41.7% |
| B-9 | 91.5% | 4.8% | 1.1% | 0.5% | 2.1% | 3.0% | 40.5% |
| B-10 | 91.5% | 4.8% | 1.1% | 0.5% | 2.1% | 3.1% | 40.5% |
| B-11 | 91.4% | 4.8% | 1.1% | 0.5% | 2.2% | 3.1% | 39.5% |
| B-12 | 91.5% | 4.8% | 1.1% | 0.5% | 2.1% | 2.9% | 39.0% |
| B-13 | 91.4% | 4.8% | 1.1% | 0.5% | 2.2% | 3.1% | 39.6% |
| B-14 | 91.4% | 4.8% | 1.1% | 0.5% | 2.2% | 3.2% | 39.7% |
| B-15 | 91.3% | 4.8% | 1.1% | 0.5% | 2.3% | 3.3% | 41.7% |
| B-16 | 91.5% | 4.8% | 1.1% | 0.5% | 2.1% | 3.2% | 40.0% |
| B-17 | 91.3% | 4.8% | 1.1% | 0.5% | 2.3% | 3.3% | 41.2% |
| B-18 | 91.4% | 4.8% | 1.1% | 0.5% | 2.2% | 3.1% | 40.0% |
| B-19 | 91.0% | 4.8% | 1.1% | 0.5% | 2.6% | 3.0% | 40.1% |
| B-20 | 91.4% | 4.8% | 1.1% | 0.5% | 2.3% | 3.3% | 39.1% |
| B-21 | 91.2% | 4.8% | 1.1% | 0.5% | 2.4% | 3.5% | 41.5% |
| B-22 | 91.3% | 4.8% | 1.1% | 0.5% | 2.3% | 3.2% | 39.1% |
| B-23 | 91.4% | 4.8% | 1.1% | 0.5% | 2.2% | 3.3% | 40.6% |
| B-24 | 91.3% | 4.8% | 1.1% | 0.5% | 2.3% | 3.2% | 41.8% |
| B-25 | 91.5% | 4.8% | 1.1% | 0.5% | 2.1% | 3.4% | 40.7% |
| B-26 | 91.5% | 4.8% | 1.1% | 0.5% | 2.1% | 3.3% | 40.4% |
| B-27 | 91.6% | 4.8% | 1.1% | 0.5% | 2.0% | 3.2% | 39.2% |
| B-28 | 91.5% | 4.8% | 1.1% | 0.5% | 2.1% | 3.1% | 40.2% |
| B-29 | 90.9% | 4.8% | 1.1% | 0.5% | 2.7% | 3.3% | 41.7% |
| B-30 | 91.2% | 4.8% | 1.1% | 0.5% | 2.4% | 3.3% | 41.5% |
| Mean | 91.5% | 4.8% | 1.1% | 0.5% | 2.2% | 3.1% | 40.5% |

(1) “First processed molding material” refers here to the amount of molding material from the previous loop that has been reused after processing
(2) Added dose of water
(3) Measured water content of the mixture

TABLE 42
Indices of samples taken in the respective loops for
determination of the molding material properties

| | Processed | | | | | |
|---|---|---|---|---|---|---|
| | starting | | | | | |
| | molding | Active | Green | | Gas | |
| | material | clay | compressive | | perme- | |
| | [propn. | content | strength | 100*WTS | ability | Flow- |
| Loop | by wt.] | [%] | [N/cm²] | [N/cm²] | index | ability |
| B-1 | 92% | 5.2% | 22.5 | 38.2 | 147 | 53% |
| B-2 | 85% | 5.6% | 21.8 | 33.0 | 133 | 53% |
| B-3 | 77% | 5.6% | 22.1 | 30.2 | 130 | 65% |
| B-4 | 71% | 5.6% | 21.4 | 30.5 | 127 | 63% |
| B-5 | 65% | 5.8% | 21.3 | 31.7 | 136 | 63% |
| B-6 | 60% | 5.7% | 21.4 | 33.3 | 135 | 62% |
| B-7 | 54% | 5.6% | 19.8 | 33.7 | 139 | 57% |
| B-8 | 50% | 5.8% | 20.5 | 31.0 | 155 | 67% |
| B-9 | 46% | 5.9% | 20.4 | 31.7 | 142 | 54% |
| B-10 | 42% | 5.6% | 20.6 | 37.2 | 143 | 58% |
| B-11 | 38% | 5.8% | 20.1 | 31.7 | 127 | 59% |
| B-12 | 35% | 6.0% | 20.9 | 32.2 | 130 | 50% |
| B-13 | 32% | 6.1% | 20.4 | 30.4 | 126 | 55% |
| B-14 | 29% | 6.1% | 18.9 | 33.7 | 163 | 51% |
| B-15 | 27% | 6.1% | 19.0 | 34.0 | 160 | 52% |
| B-16 | 24% | 6.0% | 19.7 | 32.4 | 154 | 50% |
| B-17 | 22% | 6.1% | 19.2 | 34.1 | 136 | 57% |
| B-18 | 20% | 6.1% | 18.3 | 34.4 | 172 | 61% |
| B-19 | 18% | 5.7% | 17.8 | 31.8 | 152 | 61% |
| B-20 | 17% | 5.6% | 19.0 | 32.3 | 133 | 61% |
| B-21 | 15% | 5.7% | 18.3 | 31.7 | 144 | 52% |
| B-22 | 14% | 6.3% | 18.8 | 32.7 | 169 | 53% |
| B-23 | 13% | 6.2% | 18.9 | 31.5 | 159 | 55% |
| B-24 | 12% | 6.5% | 18.3 | 31.9 | 177 | 57% |
| B-25 | 11% | 6.2% | 18.8 | 32.5 | 135 | 58% |
| B-26 | 10% | 6.3% | 18.5 | 34.5 | 141 | 53% |
| B-27 | 9% | 6.4% | 18.2 | 31.5 | 152 | 60% |
| B-28 | 8% | 6.1% | 18.6 | 30.1 | 141 | 60% |
| B-29 | 7% | 6.2% | 18.3 | 33.0 | 137 | 55% |
| B-30 | 7% | 5.5% | 19.8 | 30.9 | 125 | 62% |
| Mean | | 5.9% | 19.7 | 32.6 | 144 | 57.3% |

TABLE 43
Analysis of molding material samples from selected loops

| | Processed | | | | | | | | | |
|---|---|---|---|---|---|---|---|---|---|---|
| | starting | | | | | | | | | |
| | molding | | | | | | Mean | | | |
| | material | Ignition | C | N | S | | grain | | Degree | |
| | [propn. | loss | content | content | content | Sludge | size | AFS | of uni- | Fines <0.125 |
| Loop | by wt.] | [wt %] | [wt %] | [wt %] | [wt %] | [wt %] | [mm] | number | formity | mm [wt %] |
| B-1 | 92% | 3.60 | 2.41 | 0.04 | 0 | 10.9 | 0.3 | 53 | 59.2 | 3.08 |
| B-4 | 71% | 3.33 | 1.91 | 0.04 | 0.03 | 10.8 | 0.29 | 54 | 60.1 | 3.91 |
| B-8 | 50% | 3.03 | 1.59 | 0.05 | 0.03 | 11.0 | 0.29 | 54 | 58.0 | 4.97 |
| B-12 | 35% | 2.76 | 1.25 | 0.04 | 0.01 | 11.0 | 0.29 | 54 | 57.9 | 5.31 |
| B-16 | 24% | 2.74 | 1.18 | 0.05 | 0.01 | 10.8 | 0.3 | 52 | 57.3 | 4.82 |
| B-20 | 17% | 2.56 | 0.95 | 0.04 | 0.01 | 10.9 | 0.31 | 53 | 56.5 | 4.95 |
| B-24 | 12% | 2.46 | 0.75 | 0.04 | 0.01 | 10.8 | 0.32 | 51 | 56.7 | 4.12 |
| B-28 | 8% | 2.29 | 0.71 | 0.04 | 0.01 | 10.9 | 0.31 | 52 | 56.0 | 4.34 |
| B-30 | 7% | 2.32 | 0.65 | 0.04 | 0.01 | 10.8 | 0.31 | 51 | 56.2 | 4.22 |

Molding material analysis (table 43) shows that the ignition loss of the molding material decreases as the number of loops progresses. At the same time, the level of carbon (C), sulfur and nitrogen (N) is reduced, with the C and N levels approaching limits that are determined by the admixture of coldbox-bound core sand. Here, the molding material properties remain essentially unchanged (table 42).

Also determined in this experiment series is the surface roughness of the castings (table 44). It is observed that good surfaces are obtained in spite of the decreasing proportion of carbon in the molding material. No casting defects can be observed.

TABLE 44
Surface roughnesses of castings produced in the course of experiment series B

| Loop | B-1 | B-4 | B-6 | B-8 | B-12 | B-16 | B-20 | B-24 | B-30 | Mean |
|---|---|---|---|---|---|---|---|---|---|---|
| Proportion of starting | 92% | 71% | 60% | 50% | 35% | 24% | 17% | 12% | 7% | |
| molding material | | | | | | | | | | |
| Surface roughness of | 248 | 231 | 287 | 296 | 266 | 282 | 289 | 309 | 276 | 276 |
| the casting [μm] | | | | | | | | | | |
| Standard deviation of | 31 | 40 | 41 | 51 | 38 | 54 | 47 | 56 | 29 | 43 |
| the surface roughness | | | | | | | | | | |
| of the casting [μm] | | | | | | | | | | |

3.3 Experiment Series with Admixture of Inorganically Bound Core Sand (Experiment Series C)

When producing the mold (see step (2) above), inorganically bound cores (binder Cordis 9477/Anorgit 9476, see point 0.2 above) are used, which break down in the edge layer only, but can very easily be comminuted manually.

In this experiment series with 30 loops (01-030, cf. table 45), a second processed molding material (cf. FIG. 4) produced by processing cores that had been produced with waterglass binder (Anorgit/Cordis system) was added to the above-described processed starting molding material from a brake disk foundry (point 0.2); in other words, in every subsequent loop, the processed molding material from the previous loop (first processed molding material) is refreshed with second processed molding material produced by processing cores that have been produced with waterglass binder (Anorgit/Cordis system).

TABLE 45
Composition and compactability of the molding material mixture in the individual loops

| | First | | | | | | |
|---|---|---|---|---|---|---|---|
| | processed | | | | | | |
| | molding | Addition | | | Addition | | |
| | material | of core | Addition of | Addition of | of water | | |
| | [propn. | sand | bentonite | additive | [propn. | Water | |
| | by wt.] | [propn. | [propn. | [propn. | by wt.] | content | |
| Loop | (1) | by wt.] | by wt.] | by wt.] | (2) | (3) | Compactability |
| C-1 | 91.6% | 4.8% | 1.1% | 0.5% | 2.0% | 2.7% | 42.2% |
| C-2 | 91.6% | 4.5% | 1.1% | 0.5% | 2.3% | 3.0% | 38.5% |
| C-3 | 91.6% | 4.5% | 1.1% | 0.5% | 2.3% | 3.1% | 40.6% |
| C-4 | 91.7% | 4.5% | 1.1% | 0.5% | 2.2% | 2.9% | 42.1% |
| C-5 | 91.8% | 4.5% | 1.1% | 0.5% | 2.1% | 3.1% | 39.4% |
| C-6 | 91.8% | 4.5% | 1.1% | 0.5% | 2.1% | 3.2% | 40.0% |
| C-7 | 91.6% | 4.5% | 1.1% | 0.5% | 2.3% | 3.3% | 43.0% |
| C-8 | 90.7% | 4.5% | 2.0% | 0.5% | 2.4% | 3.5% | 41.7% |
| C-9 | 91.6% | 4.5% | 1.1% | 0.5% | 2.2% | 3.3% | 40.5% |
| C-10 | 91.3% | 4.5% | 1.1% | 0.5% | 2.5% | 3.5% | 41.7% |
| C-11 | 91.5% | 4.5% | 1.1% | 0.5% | 2.4% | 3.1% | 38.9% |
| C-12 | 90.9% | 4.5% | 1.6% | 0.5% | 2.5% | 3.6% | 40.6% |
| C-13 | 91.5% | 4.5% | 1.1% | 0.5% | 2.3% | 3.4% | 41.8% |
| C-14 | 91.5% | 4.5% | 1.1% | 0.5% | 2.3% | 3.6% | 40.2% |
| C-15 | 91.6% | 4.5% | 1.1% | 0.5% | 2.2% | 3.3% | 39.8% |
| C-16 | 91.5% | 4.5% | 1.1% | 0.5% | 2.3% | 3.4% | 40.2% |
| C-17 | 91.5% | 4.5% | 1.1% | 0.5% | 2.4% | 3.6% | 41.3% |
| C-18 | 91.6% | 4.5% | 1.1% | 0.5% | 2.2% | 3.4% | 39.4% |
| C-19 | 91.4% | 4.5% | 1.1% | 0.5% | 2.5% | 3.6% | 42.2% |
| C-20 | 91.6% | 4.5% | 1.1% | 0.5% | 2.2% | 3.7% | 39.8% |
| C-21 | 92.8% | 4.6% | 0.0% | 0.5% | 2.1% | 3.3% | 39.7% |
| C-22 | 91.8% | 4.5% | 1.1% | 0.5% | 2.1% | 3.4% | 39.4% |
| C-23 | 91.6% | 4.5% | 1.1% | 0.5% | 2.2% | 3.1% | 39.3% |
| C-24 | 91.6% | 4.5% | 1.1% | 0.5% | 2.2% | 3.4% | 41.6% |
| C-25 | 91.6% | 4.5% | 1.1% | 0.5% | 2.2% | 3.4% | 39.4% |
| C-26 | 91.6% | 4.5% | 1.1% | 0.5% | 2.1% | 3.3% | 40.0% |
| C-27 | 91.6% | 4.5% | 1.1% | 0.5% | 2.2% | 3.6% | 40.4% |
| C-28 | 91.6% | 4.5% | 1.1% | 0.5% | 2.2% | 3.3% | 39.5% |
| C-29 | 91.6% | 4.5% | 1.1% | 0.5% | 2.4% | 3.6% | 42.0% |
| C-30 | 91.5% | 4.5% | 1.1% | 0.5% | 2.2% | 3.3% | 41.7% |
| Mean | 91.6% | 4.5% | 1.1% | 0.5% | 2.3% | 3.3% | 40.6% |

(1) “First processed molding material” refers here to the amount of molding material from the previous loop that has been reused after processing
(2) Added dose of water
(3) Measured water content of the mixture

TABLE 46
Indices of samples taken in the respective loops for
determination of the molding material properties

| | Processed | | | | |
|---|---|---|---|---|---|
| | starting | | | | |
| | molding | Active | Green | | |
| | material | clay | compressive | | Gas |
| | [propn. | content | strength | 100*WTS | permeability |
| Loop | by wt.] | [%] | [N/cm²] | [N/cm²] | index |
| C-1 | 92% | 5.1% | 21.36 | 33.6 | 142 |
| C-2 | 84% | 5.1% | 21.56 | 33.4 | 129 |
| C-3 | 77% | 5.5% | 21.48 | 28.8 | 117 |
| C-4 | 71% | 5.5% | 20.49 | 34.5 | 145 |
| C-5 | 65% | 5.5% | 20.39 | 32.3 | 139 |
| C-6 | 59% | 5.6% | 19.62 | 29.2 | 119 |
| C-7 | 54% | 5.4% | 19.43 | 29.2 | 117 |
| C-8 | 49% | 5.9% | 19.78 | 33.9 | 119 |
| C-9 | 45% | 6.1% | 19.46 | 34.1 | 154 |
| C-10 | 41% | 6.0% | 19.57 | 30.1 | 108 |
| C-11 | 38% | 6.0% | 18.84 | 35.5 | 175 |
| C-12 | 34% | 6.0% | 20.42 | 32.6 | 111 |
| C-13 | 31% | 6.2% | 19.72 | 33.2 | 142 |
| C-14 | 29% | 5.9% | 19.84 | 31.2 | 125 |
| C-15 | 26% | 6.0% | 19.89 | 29.2 | 126 |
| C-16 | 24% | 6.1% | 19.7 | 34.7 | 135 |
| C-17 | 22% | 6.1% | 19.63 | 30.9 | 123 |
| C-18 | 20% | 6.2% | 20.32 | 28.7 | 127 |
| C-19 | 18% | 5.9% | 19.97 | 33.5 | 142 |
| C-20 | 17% | 5.7% | 19.75 | 31.3 | 113 |
| C-21 | 16% | 5.2% | 18.37 | 31.6 | 139 |
| C-22 | 14% | 5.3% | 19.08 | 27.3 | 121 |
| C-23 | 13% | 5.3% | 18.4 | 26.3 | 150 |
| C-24 | 12% | 5.8% | 19.78 | 34.4 | 152 |
| C-25 | 11% | 6.6% | 19.04 | 31.1 | 146 |
| C-26 | 10% | 6.7% | 18.91 | 32.3 | 172 |
| C-27 | 9% | 6.5% | 20.4 | 30.3 | 111 |
| C-28 | 9% | 6.4% | 19.47 | 34.3 | 152 |
| C-29 | 8% | 6.6% | 20.22 | 31.1 | 115 |
| C-30 | 7% | 6.4% | 18.94 | 34.7 | 167 |
| Mean | | 5.9% | 19.8 | 30.0 | 134 |

TABLE 47
Analysis of samples from selected loops

| | First | | | | | | | | | |
|---|---|---|---|---|---|---|---|---|---|---|
| | processed | | | | | | | | | |
| | molding | | | | | | Mean | | | |
| | material | Ignition | C | N | S | | grain | | | |
| | [propn. | loss | content | content | content | Sludge | size | AFS | | Fines <0.125 |
| Loop | by wt.] | [wt %] | [wt %] | [wt %] | [wt %] | [wt %] | [mm] | number | Homogeneity | mm [wt %] |
| C-1 | 92% | 3.49 | 1.82 | 0.03 | 0.02 | 10.9 | 0.3 | 52 | 59.7 | 2.84 |
| C-4 | 71% | 3.01 | 1.63 | 0.03 | 0.02 | 10.8 | 0.31 | 52 | 57.5 | 3.78 |
| C-8 | 49% | 2.84 | 1.28 | 0.02 | 0.01 | 12.17 | 0.29 | 56 | 56.4 | 5.49 |
| C-12 | 34% | 2.53 | 1.07 | 0.02 | 0.02 | 11.92 | 0.3 | 54 | 55.4 | 5.2 |
| C-16 | 24% | 2.33 | 0.62 | 0.01 | 0.01 | 11.63 | 0.29 | 55 | 56.9 | 5.44 |
| C-20 | 17% | 2.17 | 0.52 | 0 | 0.01 | 12.14 | 0.29 | 56 | 54.8 | 6.08 |
| C-24 | 12% | 2.05 | 0.45 | 0 | 0 | 11.78 | 0.3 | 55 | 54.8 | 5.27 |
| C-27 | 9% | 1.79 | 0.4 | 0 | 0 | 11.22 | 0.31 | 53 | 55.6 | 4.5 |
| C-30 | 7% | 1.91 | 0.38 | 0 | 0 | 10.83 | 0.31 | 52 | 55.1 | 4.25 |

The experiments clearly show the gradual decrease in ignition loss and the levels of carbon, nitrogen and sulfur with increasing replacement of the molding material (table 47). Here, the molding material properties remain essentially unchanged (table 46).

In spite of the decreasing carbon content, no casting defects were observed and the surface roughness of the castings does not change as a result of the reduction in the carbon content (table 48).

TABLE 48
Surface roughnesses of castings produced in the course of the experiment series

| Loop | C-1 | C-6 | C-11 | C-16 | C-19 | C-23 | C-24 | C-25 | C-27 | C-30 | Mean |
|---|---|---|---|---|---|---|---|---|---|---|---|
| Proportion of | 92% | 59% | 38% | 24% | 18% | 13% | 12% | 11% | 9% | 7% | |
| starting molding | | | | | | | | | | | |
| material [wt %] | | | | | | | | | | | |
| Surface roughness | 297 | 280 | 310 | 305 | 341 | 293 | 288 | 296 | 256 | 289 | 295 |
| of the casting [μm] | | | | | | | | | | | |
| Standard deviation | 41 | 28 | 62 | 60 | 52 | 41 | 40 | 38 | 35 | 47 | 44 |
| of the surface | | | | | | | | | | | |
| roughness of the | | | | | | | | | | | |
| casting [μm] | | | | | | | | | | | |

### 3.4 Landfill Class of the Processed Molding Material

The processed molding material from all three experiment series is examined after the 30th loop (A-30, B- or C-30) and the obtained values are compared with those of the starting molding material (table 49; the abbreviation NG indicates that the measured values are below the detection limit). The finding here was as follows:

Under the German Ordinance on Landfill and Long-Term Storage (Deponieverordnung) of Jul. 4, 2020, the processed starting molding material (starting sand), on the basis of its ignition loss, TOC (total organic carbon) and its phenol index, should be classified in landfill class II. The processed molding material from experiment series B has a TOC only slightly too high for classification in landfill class I, and should therefore be classified as landfill class II, although further lowering of the TOC is possible by continued exchange or use of a different coldbox binder.

The processed molding materials from experiment series A and C are covered by landfill class I.

TABLE 49
(the abbreviation NG indicates that the measured values are below the detection limit)

| | | | | | |
|---|---|---|---|---|---|
| Parameter | Unit | Starting sand | A-30 | B-30 | C-30 |

Determination from the original substance

| | | | | | |
|---|---|---|---|---|---|
| Dry matter ⁽¹⁾ | % by wt. | 100 | 100 | 100 | 99.5 |
| Ignition loss (550° C.) ⁽²⁾ | % by wt. DM | 3.1 | 2.1 | 2.1 | 1.5 |
| TOC ⁽³⁾ | % by wt. DM | 2.6 | 0.4 | 0.8 | 0.3 |
| Extractable lipophilic | % by wt. DM | 0.05 | <0.02 | <0.02 | <0.02 |
| substances ⁽⁴⁾ | | | | | |

Determination from the 10:1 shaken eluate according to DIN EN 12457-4: 2003-01

| | | | | | |
|---|---|---|---|---|---|
| pH at 23.3° C. +/− 0.2° C. ⁽⁵⁾ | | 9.8 | 9.9 | 9.7 | 10.1 |
| Water-soluble content ⁽⁶⁾ | % by wt. | 0.43 | 1.20 | 0.95 | 0.25 |
| Total dissolved solids content ⁽⁶⁾ | mg/l | 430 | 1200 | 950 | 250 |
| Fluoride (F) ⁽⁷⁾ | mg/l | <NG | 2.1 | <NG | <NG |
| Chloride (Cl) ⁽⁷⁾ | mg/l | 3.4 | 7.4 | 5.9 | 5.8 |
| Sulfate (SO₄) ⁽⁷⁾ | mg/l | 23 | 12 | 5.2 | 8.5 |
| Readily releasable cyanide/free | mg/l | <NG | <NG | <NG | <NG |
| cyanide ⁽⁸⁾ | | | | | |
| Antimony (Sb) ⁽⁹⁾ | mg/l | 0.012 | <NG | 0.001 | <NG |
| Arsenic (As) ⁽⁹⁾ | mg/l | 0.134 | 0.005 | 0.003 | 0.006 |
| Barium (Ba) ⁽⁹⁾ | mg/l | 0.015 | 0.087 | 0.049 | 0.020 |
| Lead (Pb) ⁽⁹⁾ | mg/l | 0.002 | 0.003 | 0.003 | <NG |
| Cadmium (Cd) ⁽⁹⁾ | mg/l | <NG | <NG | <NG | <NG |
| Chromium (Cr) ⁽⁹⁾ | mg/l | <NG | <NG | <NG | <NG |
| Copper (Cu) ⁽⁹⁾ | mg/l | <NG | <NG | <NG | <NG |
| Molybdenum (Mo) ⁽⁹⁾ | mg/l | 0.002 | <NG | 0.001 | 0.001 |
| Nickel (Ni) ⁽⁹⁾ | mg/l | <NG | 0.001 | <NG | <NG |
| Mercury (Hg) ⁽¹⁰⁾ | mg/l | <NG | <NG | <NG | <NG |
| Selenium (Se) ⁽⁹⁾ | mg/l | 0.002 | <NG | 0.001 | 0.001 |
| Zinc (Zn) ⁽⁹⁾ | mg/l | <NG | 0.02 | <NG | <NG |
| Dissolved org. carbon (DOC) ⁽¹¹⁾ | mg/l | 11 | 10 | 2.6 | 7.0 |
| Phenol index, steam-volatile ⁽¹²⁾ | mg/l | 0.28 | 0.01 | 1.2 | <NG |

⁽¹⁾ Determined in accordance with DIN EN 14346: 2007-03
⁽²⁾ Determined in accordance with DIN EN 15169: 2007-05
⁽³⁾ Determined in accordance with DIN EN 15936: 2012-11 (AN, L8: Ver. A; FG, F5: Ver. B)
⁽⁴⁾ Determined in accordance with Mitteilung der Länderarbeitsgemeinschaft Abfall Mitteilung 35 [Communication 35 of the German Joint Interregional Working Group on Waste] abbreviation: KW/04: 2019-09
⁽⁵⁾ Determined in accordance with DIN EN ISO 10523 (C5): 2012-04
⁽⁶⁾ Determined in accordance with DIN EN 15216: 2008-01
⁽⁷⁾ Determined in accordance with DIN EN ISO 10304-1 (D20): 2009-07
⁽⁸⁾ Determined in accordance with DIN EN ISO 14403-2: 2012-10
⁽⁹⁾ Determined in accordance with DIN EN ISO 17294-2 (E29): 2017-01
⁽¹⁰⁾ Determined in accordance with DIN EN ISO 12846 (E12): 2012-08
⁽¹¹⁾ Determined in accordance with DIN EN 1484: 2019-04
⁽¹²⁾ Determined in accordance with DIN EN ISO 14402 (H37): 1999-12

### 3.5 BTX Emission Potential of the Processed Molding Material

The starting molding material from the conditioned molding material loop of the brake disk foundry and the molding materials from loops A-30, B-30 and C-30 were examined with regard to their BTX emission potential. For this purpose, the samples are dried at 105° C. and then crushed in a planetary ball mill (Retsch Planetary Ball Mill PM100CM) at 300 rpm for 2 minutes under low-temperature conditions (vessel: 150 ml stainless steel cup with stainless steel balls). There is cooling at −20° C. for at least 12 hours, i.e. the grinding cup of the planetary ball mill was stored at −20° C. for at least 12 hours before use in order to avoid excessive heating of the sample during the grinding operation. Then 10 mg of sample is weighed into a pyrolysis tube. A double determination is conducted for each sample. The measurements are conducted with the following equipment:
GERSTEL MPS
GERSTEL TDU 2 with pyrolysis module
Agilent 8890B gas chromatograph with Agilent 5977 mass spectrometer
RESTEK 13868 RXI-624Sil MS capillary column, −60° C.-300° C. (320° C.): 30 m×250 μm×1.4 0.25 mm
150 ml stainless steel grinding beaker and stainless steel grinding balls
Hamilton electronic holder (VWR Art. No. HAMIDS86200)
Hamilton 1 μl syringe (VWR Art. No. 549-1224)
Carbotrap B packed glass inlet liners (upper temperature limit 450° C.) (Gerstel Art. No. 013248-005-00)
Quartz pyrolysis tubes (Gerstel Art. No. 018437-020-00)
Carbopack™ B, 60-80 net adsorbent matrix (VWR Art. No. SUPL20273)
Glass wool, silanized (VWR Art. No. SERA22367.01)

The following conditions are observed:

### Gas Chromatography (GC) Parameters

| | |
|---|---|
| Temperature program | starting temperature 40° C., hold time 4 min |
| | 20° C./min at 60° C., hold time 35 min |
| | 25° C./min at 300° C., hold time 10 min |
| Carrier gas | Helium 4.6 |
| Inlet Mode | Solvent vent |
| Purge flow at split outlet | 100 ml/min at 0.02 min |
| Flow rate | 50 ml/min at 7.5 psi to 0.01 min |

### PTV Parameters

(PTV=programmed temperature vaporization system—, i.e. the sample is pyrolyzed, the pyrolysis gases are condensed and then volatilized for GC analysis)

| | | |
|---|---|---|
| Starting temperature | −4° | C. |
| Equilibration time | 0.05 | min |

| | |
|---|---|
| Cryogenic cooling used | yes: |
| Temperature ramp 1 | 16° C./s, end temperature 150° C., |
| | hold time 0.1 min |
| Temperature ramp 2 | 12° C./s, end temperature 320° C., |
| | hold time 10 min |

Calibration method:

MSD parameters (MSD=mass spectrometry detector)

| Tune File | etune | |
|---|---|---|
| Transfer line temperature | 300° | C. |
| Ion source temperature | 230° | C. |
| Quad temperature | 150° | C. |
| Gain factor | 1000 | |
| Ionization mode | Electron impact ionization (EI), 70 eV | |
| Solvent exposure time | 5.5 | min |

| | |
|---|---|
| Mode | Scan mode, mass range 35-400 amu, |
| | threshold 40, scan speed 1562 u/s |

### TDU Parameters (TDU=Thermal Desorption Unit)

| | | |
|---|---|---|
| Starting temperature | 25° | C. |
| Delay time | 0.60 | min. |

| | |
|---|---|
| Temperature ramp 1 | Rate: 600° C./min |
| | End temperature: 350° C. |
| | Hold time: 5.10 min |

### Pyrolysis Parameters

| | | |
|---|---|---|
| Initial period | 0.10 | min |
| Starting temperature | 350° | C. |
| Starting time | 4 | min |

| | |
|---|---|
| Heater off | yes |

Calibration was effected with standards based on benzene, toluene; m- and p-xylene; styrene; o-xylene; ethylbenzene, cumene.

Sample method:

### MSD Parameters

| Tune File | etune | |
|---|---|---|
| Transfer line temperature | 300° | C. |
| Ion source temperature | 230° | C. |
| Quad temperature | 150° | C. |
| Gain factor | 1000 | |
| Ionization mode | Electron impact ionization (EI), 70 eV | |
| Solvent exposure time | 0 | min |

| | |
|---|---|
| Mode | Scan mode, mass range 35-400 amu, |
| | threshold 40, scan speed 1562 u/s |

### TDU Parameters

| | | |
|---|---|---|
| Starting temperature | 25° | C. |
| Delay time | 0.60 | min. |

| | |
|---|---|
| Temperature ramp 1 | Rate: 100° C./min |
| | End temperature: 35° C. |
| | Hold time: 11.10 min |
| Temperature ramp 2 | Rate: 600° C./min |
| | End temperature: 50° C. |

### Pyrolysis Parameters

| | | |
|---|---|---|
| Initial period | 0.10 | min |
| Starting temperature | 900° | C. |
| Starting time | 10 | min |

| | |
|---|---|
| Heater off | yes |

### Indices of the Method

| | |
|---|---|
| Linearity | Benzene: R² = 0.989122 |
| | Toluene: R² = 0.993010 |
| | Ethylbenzene: R² = 0.992232 |
| | m-, p-xylene: R² = 0.996029 |
| | o-xylene: R² = 0.998304 |
| | Styrene: R² = 0.997786 |
| | Cumene: R² = 0.997454 |
| Working range | Benzene: 500-10000 ng (absolute), 50-1000 mg/kg |
| | Toluene: 500-10000 ng (absolute), 50-1000 mg/kg |
| | Ethylbenzene: 15-300 ng (absolute), 2-30 mg/kg |
| | m-, p-xylene: 45-900 ng (absolute), 5-90 mg/kg |
| | o-xylene: 20-250 ng (absolute), 2-25 mg/kg |
| | Styrene: 45-900 ng (absolute), 5-90 mg/kg |
| | Cumene: 81-500 ng (absolute), 8-50 mg/kg |
| Detection limit | Benzene: LOD = 1.30 ng (absolute) |
| | Toluene: LOD = 1.82 ng (absolute) |
| | Ethylbenzene: LOD = 0.05 ng (absolute) |
| | m-, p-xylene: LOD = 0.29 ng (absolute) |
| | o-xylene: LOD = 0.04 ng (absolute) |
| | Styrene: LOD = 0.14 ng (absolute) |
| | Cumene: LOD = 26.68 ng (absolute) |
| Determination limit | Benzene: DL = 3.94 ng (absolute), 0.39 mg/kg |
| | Toluene: DL = 4.97 ng (absolute), 0.50 mg/kg |
| | Ethylbenzene: DL = 0.09 ng (absolute), 0.01 mg/kg |
| | m-, p-xylene: DL = 0.61 ng (absolute), 0.06 mg/kg |
| | o-xylene: DL = 0.07 ng (absolute), 0.01 mg/kg |
| | Styrene: DL = 0.20 ng (absolute), 0.02 mg/kg |
| | Cumene: DL = 80.84 ng (absolute), 8.08 mg/kg |

Evaluation was effected with the MassHunter software.

The results shown in table 50 clearly show that the pollutant emissions can be significantly lowered by using an additive of the invention. Emission potential is significantly lowered especially in combination with inorganic cores or when fresh mold base material (new sand) is fed into the molding material cycle. A clear effect is also observed when coldbox core sand is fed in. Emission potential is reduced by more than 45% in the model case.

TABLE 50
Pyrolysis (GC-MS) of the molding materials after 30 loops compared to the
starting molding material (all data as mg emission/kg sample material)

| | | Starting | Experiment | Experiment | Experiment |
|---|---|---|---|---|---|
| Sample | | molding | series A | series B | series C |
| Parameter | Unit | material | after 30 loops | after 30 loops | after 30 loops |
| Benzene | mg/kg | 309 | 27 | 188 | 37 |
| Toluene | mg/kg | 82 | 5 | 25 | 7 |
| Ethylbenzene | mg/kg | 9 | <2 | <2 | <2 |
| m-, p-xylene | mg/kg | 12 | <5 | <5 | <5 |
| o-xylene | mg/kg | <2 | <2 | <2 | <2 |
| Styrene | mg/kg | <16 | <16 | <16 | <16 |
| Cumene | mg/kg | <8 | <8 | <8 | <8 |
| BTEX at 900° C. | mg/kg | 412-414 | 37-46 | 213-222 | 44-53 |

In table 50, “< . . . ” means that the content of the BTEX compound in question is below its detection limit.

In respect of the ranges of values in the “BTEX at 900° C.” line:

The lower limit corresponds to the sum total of the contents of BTEX compounds that are above the respective detection limit, such that it was possible to determine a value (in the case of the starting molding material, these are benzene, toluene, ethylbenzene and m-, p-xylene).

The upper limit corresponds to the sum total of the lower limit and the detection limits of each BTEX compound having a content below the respective detection limit (in the case of the starting molding material, these are o-xylene, styrene and cumene).

We claim:

1. A method of guiding a molding material in a molding material cycle comprising two or more loops, comprising the following steps:
in an earlier loop of said two or more loops of the molding material cycle, casting in a mold comprising the smectite-containing clay-bound molding material, resulting in a molding material that has been used for casting,
processing the molding material used for casting so as to result in a first processed molding material,
in a later loop of said two or more loops of the molding material cycle, producing a molding material comprising
(i) first processed molding material,
and
(ii) aggregates comprising
one or more raw materials from the group consisting of
mold base material,
a second processed molding material produced by processing molding material from molds that have not been used for casting and/or cores and/or parts thereof that have been produced with an inorganic binder,
a third processed molding material produced by processing molds used for casting outside the molding material cycle and/or cores and/or parts thereof that have been produced with an inorganic binder,
an additive containing at least one dehydratable inorganic compound that eliminates water at a temperature of 150° C. or more,
and optionally smectite-containing clay,
wherein at least one of the processed molding materials contains inorganic binder and/or reaction products thereof.

2. The method as claimed in claim 1, wherein the casting is effected in a mold with at least one inserted core that has been produced with an inorganic binder, resulting in a molding material that has been used for casting and comprises material from the mold used for casting and material from the core used for casting.

3. The method as claimed in claim 1, wherein the smectite-containing clay is bentonite.

4. The method as claimed in claim 1, wherein the inorganic binder contains waterglass.

5. The method as claimed in claim 1, wherein the additive contains one or both compounds from the group consisting of aluminum hydroxide and magnesium hydroxide.

6. The method as claimed in a claim 1, wherein
the mold is used for casting with iron.

7. The method as claimed in claim 1, wherein the molding material discharged in the course of processing meets the requirements for landfill class DK I in accordance with Annex 3 of the German Ordinance on Landfills and Long-Term Disposal (Deponieverordnung—DepV) of Apr. 27, 2009.

8. The method as claimed in claim 1, wherein the molding material produced in the later cycle has one or more of the following parameters:
a concentration of less than 1.5% carbon, based on the mass of the molding material, determined by elemental analysis
a concentration of less than 0.1% of nitrogen, based on the mass of the molding material, determined by elemental analysis
a concentration of less than 0.05% of sulfur, based on the mass of the molding material, determined by elemental analysis
an ignition loss of not more than 5% determined in accordance with VDG-Merkblatt P33 (April 1997).

9. The method of claim 1, wherein the at least one dehydratable inorganic compound of the additive comprises a hydroxide or hydrate salt of a metal.
